(19) United States
(12) Patent Application Publication
(10) Pub. No.: US 2010/0217717 A1
(43) Pub. Date: Aug. 26, 2010

(54) SYSTEM AND METHOD FOR ORGANIZING AND PRESENTING EVIDENCE RELEVANT TO A SET OF STATEMENTS

(75) Inventor: Walter Overby, Atlanta, GA (US)

Correspondence Address: SMITH FROHWEIN TEMPEL GREENLEE BLAHA, LLC, Two Ravinia Drive, Suite 700, ATLANTA, GA, 30346, US

(73) Assignee: DEVONWOOD LOGISTICS, INC., Atlanta, GA (US)

(21) Appl. No.: 12/706,496

(22) Filed: Feb. 16, 2010

Related U.S. Application Data
(60) Provisional application No. 61/154,891, filed on Feb. 24, 2009.

(51) Int. Cl. G06Q 50/00; G06Q 99/00; G06F 3/048

(52) U.S. Cl. 705/311; 715/764

(57) ABSTRACT

Evidence relevant to a set of statements can be organized and presented to a user using a suitably programmed computer system. The computer system accepts as input from the user a set of statements, a set of argument tags associated with each statement, a set of evidence items, and a set of argument tags associated with each evidence item. The computer then collects, for each statement, the group containing any evidence item that is relevant to the statement, where relevance is indicated by at least one argument tag shared between the argument tags associated with the statement and the argument tags associated with the evidence item. The computer then presents the set of statements and, for each statement, the evidence items relevant to the statement.

### CROSS-REFERENCE TO RELATED APPLICATION

The benefit of the filing date of U.S. Provisional Patent Application No. 61/154,891, filed Feb. 24, 2009, entitled “SYSTEM AND METHOD FOR ORGANIZING AND PRESENTING EVIDENCE RELEVANT TO A SET OF STATEMENTS,” is hereby claimed and the specification thereof incorporated herein in its entirety by this reference.

### BACKGROUND

In argumentation, and particularly in legal argumentation, it is common to present evidence using a chart. For example, in patent law, lawyers prepare claim charts that show claim elements in the first column, and a list of evidence in the other columns. Each evidence column may contain a list of evidence taken from a particular source, called a reference. A reference may be a book, an article, a web page, personal testimony, or another source of evidence. The list of evidence is made up of excerpts from the reference. The claim elements describe the invention described in that patent, and the evidence list alongside each element supports the legal purpose of the chart. That purpose might be, for example, proving anticipation, enablement, or infringement.

More generally, these charts are based on statements, such as the claim elements. Each statement is associated with evidence from each column. Taken as a whole, the purpose of the chart is to present, for each statement, all of the evidence needed to prove the chart author's arguments for that statement. The arguments themselves, however, may not always be explicit in the final chart. Likewise, the chart may not be designed to make clear the reasons why a particular evidence item is used in the chart. Chart authors may find it helpful to separately document the arguments and other decisions that affect the contents of the chart. For example, the chart author may document how strongly an evidence item supports an argument. These separate documents, like the charts themselves, may be electronic data files, or hard copies.

Charts may be repetitive. For example, if the author makes the same argument for a number of statements, the evidence supporting that argument may be repeated. If an evidence item supports more than one argument, it may appear alongside many statements. Patent claim charts, in particular, are often repetitive because claim elements are frequently repeated between claims within the same patent, or between patents in a family of patents. These charts may be quite long and require significant effort to draw up. Furthermore, the charts are difficult to change. Small changes in the arguments or evidence, for example, may cause significant changes in the final chart. In some cases, the impact of a particular change may not be clear until the entire chart is drawn up again. In patent litigation, new claims or even entirely new patents may be added to the chart. Often, the new claim elements overlap only partially with the old, and it may be possible to reuse some, but perhaps not all, of the existing chart evidence. Refining the evidence lists to match the new claim elements takes time and effort.

Conventional methods for creating charts usually rely on familiar computer software for word processing, such as Microsoft Word. These methods require manual editing for each change to the charts. For large charts, the word processing effort required to draw up the chart makes it difficult to revise the chart in a timely and accurate way. Software tools exist for locating concepts within patents or other documents. These tools can help identify useful evidence, but they do not assist in organizing the statements, arguments, and evidence that underlie a claim chart, and do not help to document the reasoning of the author of the chart.

### SUMMARY

Embodiments of the present invention relate to a system and method for organizing and presenting evidence relevant to a set of statement. In an exemplary embodiment, a suitably programmed computer system can effect the method. In the exemplary embodiment, the computer system accepts as input a set of statements, a set of argument tags associated with each statement, a set of evidence items, and a set of argument tags associated with each evidence item. The computer then collects, for each statement, the group containing any evidence item that is relevant to the statement, where relevance is indicated by at least one argument tag shared between the argument tags associated with the statement and the argument tags associated with the evidence item. The computer then presents the set of statements and, for each statement, the evidence items relevant to the statement.

Other systems, methods, features, and advantages of the invention will be or become apparent to one with skill in the art upon examination of the following figures and detailed description.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding elements throughout the different figures.

FIG. 1 illustrates a window that displays document data, in accordance with an exemplary embodiment of the invention.

FIG. 2 illustrates a navigation pane in the exemplary embodiment.

FIG. 3a illustrates a blank content pane in the exemplary embodiment.

FIG. 3b illustrates a content pane in the exemplary embodiment with a simple list of items.

FIG. 3c illustrates a content pane in the exemplary embodiment with a complex list of items.

FIG. 4 illustrates a number of user interface elements suitable for editing information in the exemplary embodiment.

FIG. 5 illustrates a patent content pane in the exemplary embodiment showing the first patent content items.

FIG. 6 illustrates a patent editing pane in the exemplary embodiment when the patent collection is the selected navigation item.

FIG. 7 illustrates a patent editing pane in the exemplary embodiment when a patent is the selected navigation item.

FIG. 8 illustrates an element editing pane in the exemplary embodiment.

FIG. 9 illustrates a tags collection content pane in the exemplary embodiment.

FIG. 10 illustrates a tag editing pane in the exemplary embodiment.

FIG. 11 illustrates a patent content pane in the exemplary embodiment showing items from the middle of the patent content.

FIG. 12 illustrates a tag selection window in the exemplary embodiment.

FIG. 13 illustrates an element tagging editing pane in the exemplary embodiment.

FIG. 14 illustrates a reference content pane in the exemplary embodiment.

FIG. 15 illustrates a reference editing pane in the exemplary embodiment when the reference collection is the selected navigation item.

FIG. 16 illustrates a reference editing pane in the exemplary embodiment when a reference is the selected navigation item.

FIG. 17 illustrates an excerpt editing pane in the exemplary embodiment.

FIG. 18 illustrates an excerpt tagging editing pane in the exemplary embodiment.

FIG. 19 illustrates a combination content pane in the exemplary embodiment.

FIG. 20 illustrates the combination editing pane in the exemplary embodiment when the combination collection is the selected navigation item.

FIG. 21 illustrates the combination editing pane in the exemplary embodiment when a combination is the selected navigation item.

FIG. 22 illustrates a restricted reference editing pane in the exemplary embodiment.

FIG. 23 illustrates a reference selection window in the exemplary embodiment.

FIG. 24 illustrates a tag restrictions window in the exemplary embodiment.

FIG. 25 illustrates a reports collection content pane in the exemplary embodiment.

FIG. 26 illustrates a report editing pane in the exemplary embodiment.

FIG. 27 illustrates a report type selection window in the exemplary embodiment.

FIG. 28 illustrates a functional tags section of the tags report file in the exemplary embodiment.

FIG. 28b illustrates a patent chart section of the tags report file in the exemplary embodiment.

FIG. 29 illustrates a tags report options window in the exemplary embodiment.

FIG. 30 illustrates a patent collection editing window in the exemplary embodiment.

FIG. 31 illustrates a references report options window in the exemplary embodiment.

FIG. 32 illustrates a reference collection editing window in the exemplary embodiment.

FIG. 33a illustrates a tagging chart section of the references report file in the exemplary embodiment.

FIG. 33b illustrates an unused tags section of the references report file in the exemplary embodiment.

FIG. 34 illustrates a prior art collection editing window in the exemplary embodiment.

FIG. 35 is a flow chart illustrating a method for assembling relevant evidence for a statement.

FIG. 36 is a flow chart illustrating a method for filtering a collection of evidence tags against a collection of statement tags.

FIG. 37 illustrates an anticipation report options window in the exemplary embodiment.

FIG. 38 illustrates a chart from the anticipation report file in the exemplary embodiment.

FIG. 39 illustrates an invalidity contentions with citations report options window in the exemplary embodiment.

FIG. 40 illustrates a chart in the invalidity contentions with citations report file in the exemplary embodiment.

FIG. 41 shows item groupings valid for a range of item counts in the exemplary embodiment.

FIG. 42 illustrates an invalidity contentions with key report options window in the exemplary embodiment.

FIG. 43a illustrates a chart in an invalidity contentions with key report file in the exemplary embodiment.

FIG. 43b illustrates the key in an invalidity contentions with key report file in the exemplary embodiment.

FIG. 44 illustrates a computer system programmed to effect a method for organizing and presenting evidence relevant to a set of statements, in accordance with the exemplary embodiment.

FIG. 45 is a flow chart illustrating a method for assembling relevant evidence for a set of statements, in accordance with the exemplary embodiment.

FIG. 46 is a flow chart illustrating a method by which the invention operates, in response to user input, and in accordance with the exemplary embodiment.

### DETAILED DESCRIPTION

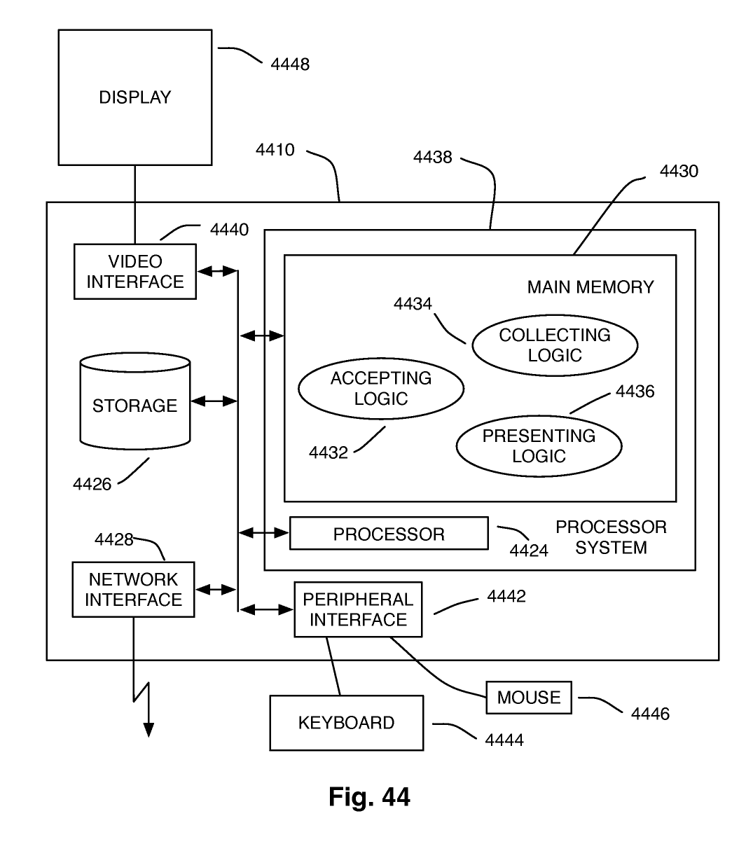

As illustrated in FIG. 44, in an exemplary or illustrative embodiment of the invention, a computer 4410 operates under control of suitable programming and user input to organize and present evidence relevant to a set of statements. In the exemplary embodiment, the invention facilitates the preparation of patent claim charts. For example, a person such as the user may wish to produce a chart or similar output that relates each element set forth in a claim of a patent to one or more items of evidence for the purpose of arguing that the claim is anticipated by the prior art. In such an instance, the prior art is represented by items of evidence. For example, an item of evidence may be an excerpt from a book or other reference. Similarly, a person may wish to produce a chart or similar output that relates each element set forth in a claim of a patent to one or more items of evidence for the purpose of arguing that the claim is infringed by a product. In such an instance, the product is represented by items of evidence. For example, an item of evidence may be a description of a feature of the product. Likewise, a person may wish to produce a chart or similar output that relates each element set forth in a claim of a patent to one or more items of evidence for the purpose of analyzing whether the claim is enabled or supported by sufficient description in the specification of the patent. In such an instance, each item of evidence can be an excerpt from the specification. Although the statements and evidence in the exemplary embodiment described herein relate to analyzing patent claims, in other embodiments the statements and evidence can relate to any other suitable task in which it is desired to organize and present evidence relevant to a set of statements.

Computer 4410 can comprise any suitable elements of the types commonly included in server computers, desktop computers, or similar computing systems. For example, computer 4410 can include one or more processors 4424, data storage devices 4426, network interfaces 4428, and memory devices 4430. A peripheral interface 4442 receives input from user input devices such as a keyboard 4444 and a mouse 4446. A video interface 4440 provides output to user output devices such as a display 4448 or a printer (not shown). The one or more memory devices 4430 are generally of a type in which software modules, such as data and programming code, are operated upon by processor 4424. In accordance with conventional computing principles, processor 4424 operates under the control of programming code, such as operating system code and user program code. Such programming code, i.e., software modules, can define a method for accepting as input from a user a set of statements, a set of argument tags associated with each statement, a set of evidence items, and a set of argument tags associated with each evidence item; and for collecting, for each statement, the group containing any evidence item that is relevant to the statement, where relevance is indicated by at least one argument tag shared between the argument tags associated with the statement and the argument tags associated with the evidence item; and for presenting to the user the set of statements and, for each statement, the evidence items relevant to the statement. These software modules are described below in further detail.

Although these software modules are conceptually shown for purposes of illustration as stored or residing in memory devices 4430, it is understood that such software modules may not reside simultaneously or in their entireties in memory devices 4430 but rather may be retrieved in portions on an as-needed basis, e.g., in code segments, files, instruction-by-instruction, or any other suitable basis, from data storage 4426 or other suitable source (e.g., via data network interface 4428). Note that although only accepting logic 4432, collecting logic 4434, and presenting logic 4436 are shown for purposes of clarity, other software of the types conventionally included in computers systems that enable them to operate properly is generally included, such as operating system software. Similarly, other hardware components of the types conventionally included in computer systems can be included.

It should be noted that, as programmed with the above-described software modules, the combination of processor 4424, memory devices 4430 (or other component or components in which software modules are stored or reside) and any related components generally defines a programmed processor system 4438. It should also be noted that the combination of software modules and the medium on which they are stored or in which they reside (e.g., memory devices 4430, data storage 4426, one or more removable or portable disks (not shown), etc.) generally constitutes what is referred to in the patent lexicon as a “computer program product.”

Also, where it is stated below that the user performs some act or achieves some result, it should be understood that such a statement is intended as a convenient way of stating that computer 4410 is operating to effect or bring about the act or stated result, in accordance with user input. Similarly, where it is stated that programmed processor system 4438 performs some act or achieves some result, it should be understood that such a statement is intended as a convenient way of stating that computer 4410 is operating to effect the act or result, in accordance with the operation of programmed processor system 4438 and any user input or other information being operated upon. It should likewise be understood that the methods described below are effected by the operation of computer 4410 and its programmed processor system 4438.

The method can further include presenting to the user, for each evidence item relevant to a statement, the argument tags shared between the argument tags associated with the statement and the argument tags associated with the evidence item.

The method can further include accepting as input an annotation for any item, where an item is a statement, an argument tag, an evidence item, or an association of an argument tag with a statement or evidence item; and presenting the annotation along with the item.

The method further can include accepting as input from a user a threshold rating and a rating for each association of an argument tag with an evidence item; and then excluding from the set of argument tags associated with each evidence item all argument tags rated below the threshold rating.

In the exemplary embodiment, the set of evidence items comprises excerpts from one or more references, each reference having a citation, and each excerpt having a sub-citation, such as a page number, within a reference; and the method further includes the presentation of the citation and sub-citation of the evidence items presented.

In the exemplary embodiment, the set of statements comprises elements of one or more claims of one or more patents or publications, and the argument tags associated with each element represent anticipation arguments. In alternative embodiments, the argument tags associated with each element represent enablement or infringement arguments.

Document Window 100

In the exemplary embodiment of the invention, the programmed processor system 4438 stores information in a document-based model, as is common in office applications such as word processors or spreadsheets. In operation, the programmed processor system 4438 causes computer 4410 to display a document in its own document window 100 on the display 4448. The user interface described herein is of a graphical window-based type commonly used in application software and well understood by persons skilled in the art. As elementary graphical user interface concepts such as selecting an item from a list of displayed items, pressing a displayed button, checking a displayed checkbox, etc., are well understood by persons skilled in the art, they are not described in further detail herein. Similarly, elementary software concepts relating to conventional windows-based systems, such as communication of requests from one window or pane to another, or other software concepts that are well understood by persons skilled in the art are not described herein for purposes of clarity.

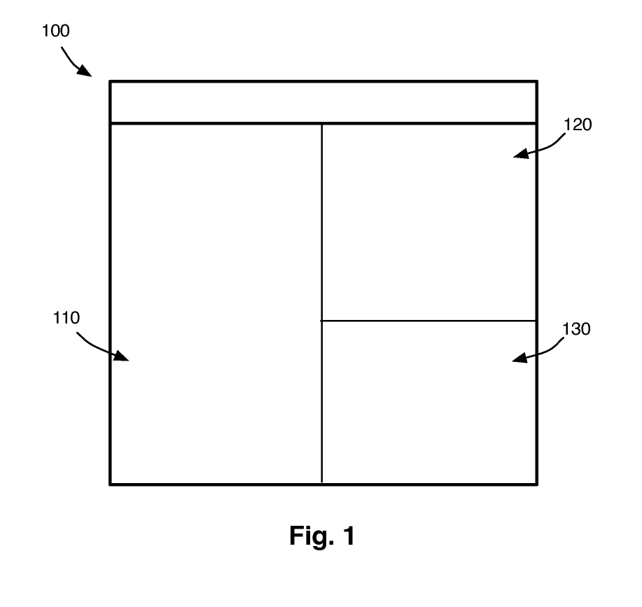

As illustrated in FIG. 1, the exemplary document window 100 has three separate sub-windows or “panes” 110, 120 and 130. In other words, the panes 110, 120 and 130, which are described below in further detail, are displayed within document window 100 on the display 4448 (FIG. 44).

Navigation Pane 110

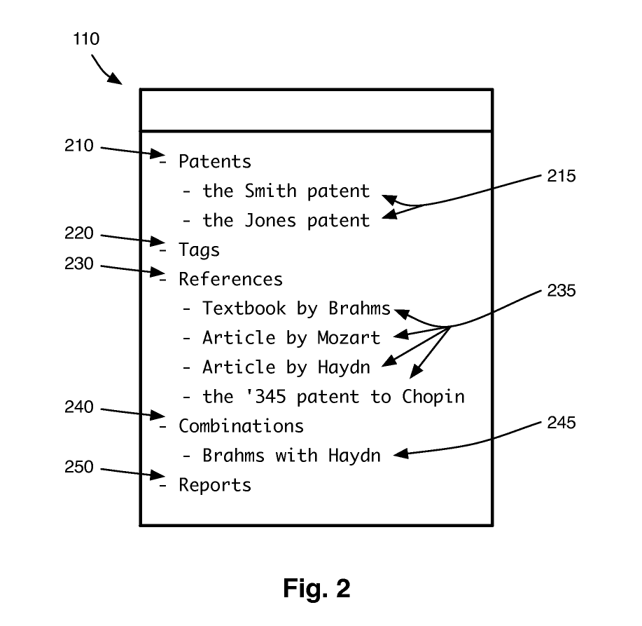

FIG. 2 shows an exemplary navigation pane 110, which displays the contents of the window in a tree structure. The navigation pane 110 is used in the manner described below with regard to an exemplary method of operation. In this example, the tree displays five items at the root level: Patents 210, Tags 220, References 230, Combinations 240, and Reports 250. The tree also shows sub-items under some root level items. Under the Patents 210 item, the tree displays an item 215 for each patent in the document. Under the References 230 item, the tree displays an item 235 for each reference in the document. Under the Combinations 240 item, the tree displays an item 245 for each combination in the document. The user selects an item or sub-item via the user interface, such as by using the mouse 4446 or keyboard 4444. The selection of an item or sub-item triggers a request from the navigation pane 110 to the content pane 120. The navigation pane 110 requests that the content pane 120 display the data represented by the selected item. The item or sub-item currently selected in the navigation pane 110 is the selected navigation item.

Content Pane 120

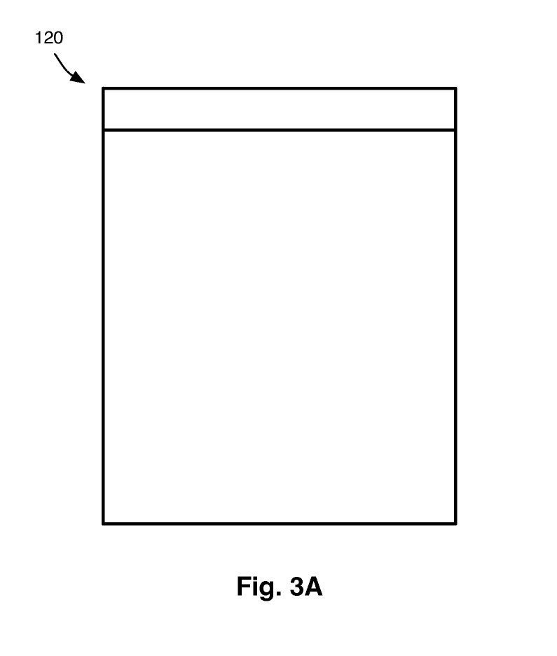

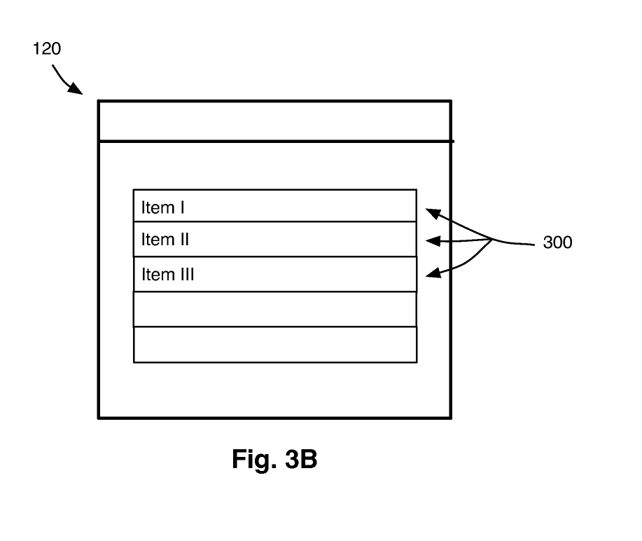

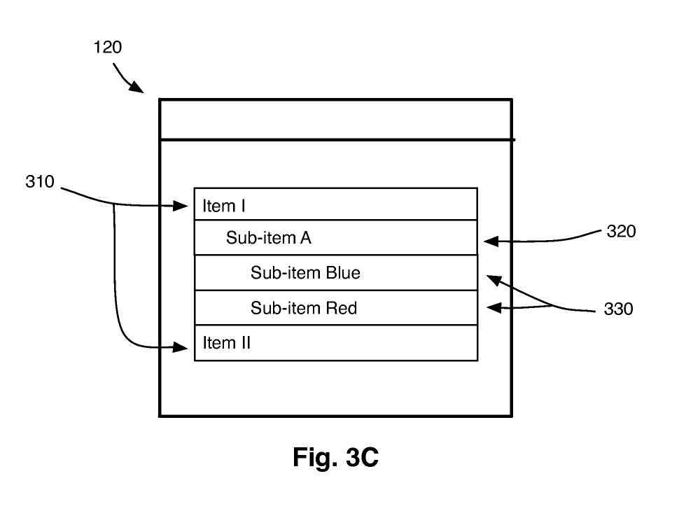

The content pane 120 displays more detailed information about the selected navigation item. For items with several parts, the content pane 120 allows the user to select parts of the item. The content pane 110 also sets the contents of the editing pane 130. FIGS. 3a-3c show three different arrangements of the content pane 120.

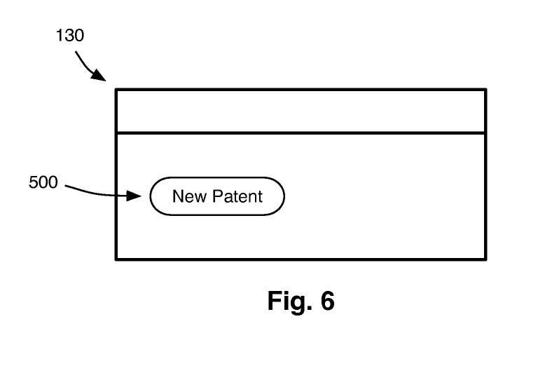

FIG. 3a shows a blank pane. When the selected navigation item is a root level item for which the tree displays sub-items, a blank content pane indicates that no sub-items exist. By default, a blank content pane triggers a request to the editing pane 130. The content pane requests that the editing pane display a button for creating a new sub-item. FIG. 6 shows an example of an editing pane with such a button 500.

FIG. 3b shows an exemplary content pane with a simple list of items. When the selected navigation item represents a group of sub-items, each containing the same kind of information, the pane lists identifying text 300 for each sub-item. The user selects a sub-item using the mouse 4446 or keyboard 4444. The selection of a sub-item triggers a request from the content pane 120 to the editing pane 130. The content pane 120 requests that the editing pane 130 display a form for editing the data represented by the selected sub-item.

FIG. 3c shows an exemplary content pane with a complex list of items. When the selected navigation item represents a group of sub-items, containing at least two different kinds of information, the pane lists identifying text 310, 320, and 330 for each sub-item. The selection of a sub-item triggers a request from the content pane 120 to the editing pane 130. The content pane 120 requests that the editing pane 130 display a form for editing the data represented by the selected sub-item.

Editing Pane 130

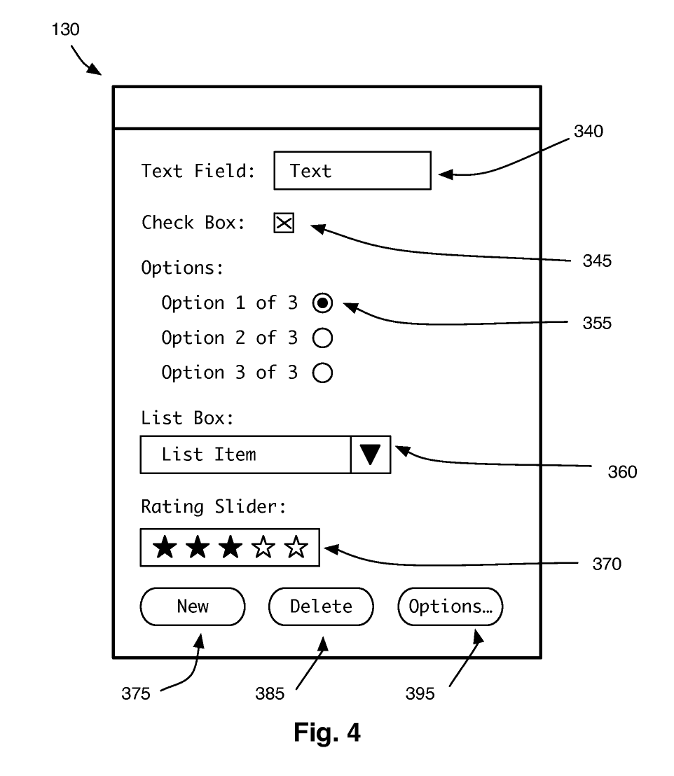

The editing pane 130 presents a user interface for editing the item selected in the content pane. This user interface can include text fields, check boxes, radio buttons and the like. It also controls the display of additional windows or panes that present further editing interfaces. The editing pane provides a control for deleting the item selected in the content pane. The editing pane provides a control for creating a new item of the same kind as the item selected in the content pane. FIG. 4 demonstrates examples of the user interface elements available in the editing pane 130 with a text field 340, a check box 345, a set of radio buttons 355, a list box 360, a rating slider 370, a new item button 375, a delete item button 385, and an options button 395. The editing pane validates user input to ensure that the data is valid. The editing pane warns the user of far-reaching changes. Editing operations propagate changes to the document window 100 as described below.

Patents

The programmed processor system 4438 associates the document window 100 with a collection of patents. FIG. 2 shows an example of this collection as represented in the navigation pane 110 at 210. When the patent collection is the selected navigation item, the editing pane provides a control for adding a new patent to the collection. FIG. 6 shows the “New Patent” button 500. The user presses the button using the mouse 4446 or keyboard 4444. When pressed, the button requests that the programmed processor system 4438 create a new patent and then add the new patent to the collection of patents associated with the document window 100.

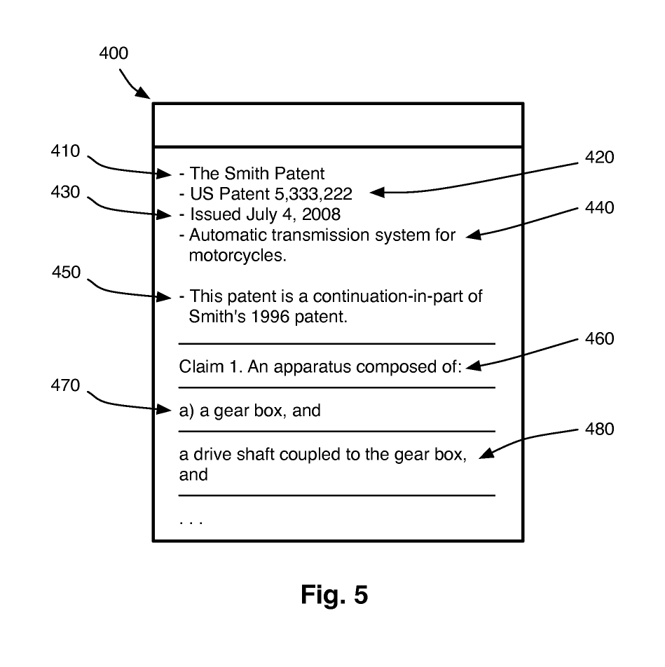

The programmed processor system 4438 creates a new patent by constructing a data structure (not shown for purposes of clarity) in the computer memory with properties that can include, for example, a unique identifier, a note, a name, a number, a title, an issue date, and a collection of elements. FIG. 5 shows a patent as represented in the content pane. The unique identifier can be, for example, a Universally Unique Identifier (UUID) as defined by RFC 4122, as known to those skilled in the art. This identifier persists between invocations of the programmed processor system 4438, and is not displayed in the document window 100. The note property holds an optional note 450 by the user of the programmed processor system 4438. The name is the phrase used to represent the patent to the user. As represented in FIG. 2 at 210 and in FIG. 5 at 410, the name can abbreviate the identifying features of the patent. The number property contains the number assigned by the entity issuing the patent. FIG. 5 shows a number 420 formatted in the manner in which the numbers of utility patents issued by the U.S. Patent and Trademark Office are formatted. The title and issue date are the title and issue dates of the issued patent, as shown in FIGS. 5 at 440 and 430 respectively. The collection of elements 460, 470, and 480 holds patent claim elements, as described in the next section.

The programmed processor system 4438 assigns default initial values to each property in the new patent data structure. These defaults suggest values a user might enter, but are intended to be replaced or customized by the user. For example, the default value of the name property is “the '555 patent.”

The programmed processor system 4438 then adds the new patent to the patent collection associated with the document window 100, and notifies the various panes of the document window of the addition. The navigation pane 110 responds to this notification by displaying the name of the new patent as a new sub-item under the Patents 210 root-level item. The new sub-item is associated with the new patent. The navigation pane 110 automatically selects the new sub-item, triggering a request that the content pane 120 display the new patent. Because a patent contains several different kinds of information, the content pane displays a complex list of items as described above regarding FIG. 3c. FIG. 5 shows an example of a patent as represented in the content pane. The first item in the list displays the patent itself. The second and subsequent items in the list display the claim elements and other information related to the patent as described in detail below. The content pane automatically selects the first item, triggering a request that the editing pane 130 display a form for editing the values of some of the properties of the patent.

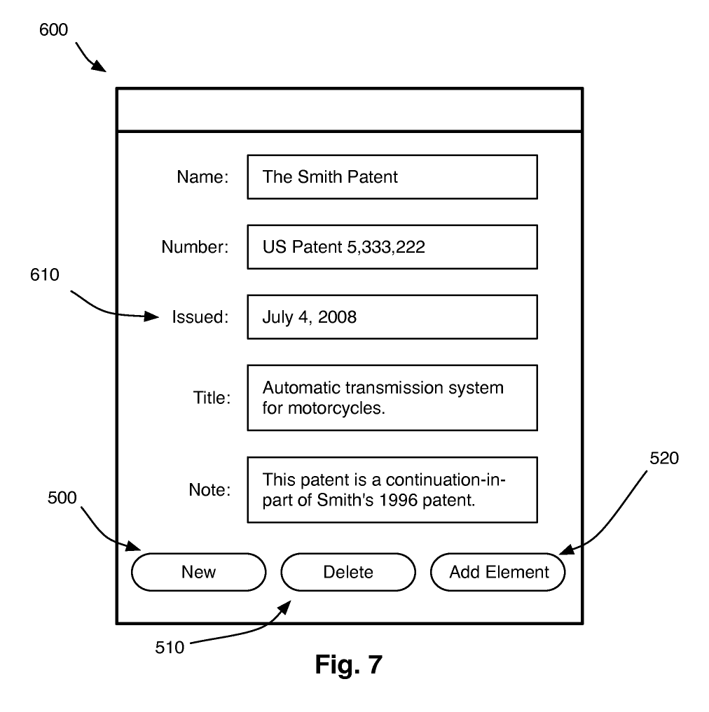

FIG. 7 shows an exemplary Patent Editing Pane 600. The form allows the user to edit the values of the properties of the patent. The form verifies that the input is a valid value for that property. For example, the issue date field 610 will prompt the user to correct any entry that is not a valid issue date. The form submits any change to the programmed processor system 4438. The programmed processor system 4438, in turn, updates the patent data structure, and notifies the various document window 100 panes of the change. The navigation pane 110 responds to this notification if the name property has changed. The navigation pane 110 updates the text of the sub-item for the patent with the new name. The content pane 120 responds to this notification by updating the display of any changed property. For example, changes to the issue date are reflected in the display of the issue date 430 in the content pane of FIG. 5.

In the exemplary embodiment, the programmed processor system 4438 allows the user to save to disk (e.g., storage 4426 in FIG. 44), or other appropriate medium, the data structures associated with the document window 100, including the patent data structures and the other data structures described herein, for retrieval at a later time.

Elements

In the exemplary embodiment, the programmed processor system 4438 associates each patent with a collection of elements. FIG. 5 shows three items 460, 470, and 480 in such a collection. When a patent is selected in the content pane 120, the editing pane provides a control for adding a new element to the collection. FIG. 7 shows the “Add Element” button 520. When pressed, the button requests that the programmed processor system 4438 create a new element and then add the new element to the collection of elements associated with the patent. The programmed processor system 4438 creates a new element by constructing a data structure in the computer memory with various properties. These properties include a unique identifier, a note, the element text, and a collection of taggings. The unique identifier and note properties function for elements as described above for patents. The element text is the text of the element as it appears in the patent claim. The collection of taggings holds tag associations, as described herein.

In the exemplary embodiment, the programmed processor system 4438 assigns default initial values to each property in the new element data structure. These defaults suggest values a user might enter, but are intended to be replaced or customized by the user. For example, the default value of the text property is “New Element.”

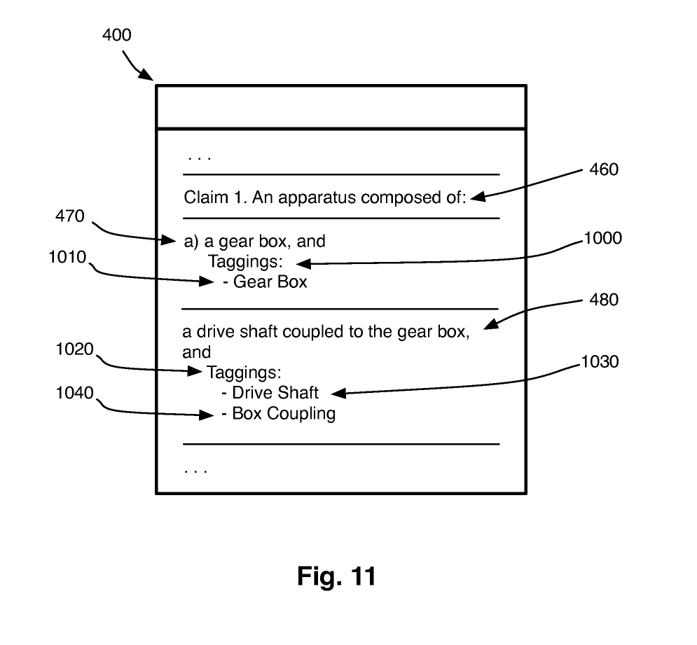

The programmed processor system 4438 then adds the new element to the element collection associated with the patent, and notifies the various panes of the document window 100 of the addition. The content pane responds to this notification by inserting a new item in the list of elements shown in FIG. 11. If the new element is the first element in the collection, the item appears after the item for the patent. Otherwise, the item appears at the end of the existing series of element items. The content pane automatically selects the new item, triggering a request that the editing pane 130 display a form for editing the values of some of the properties of the element.

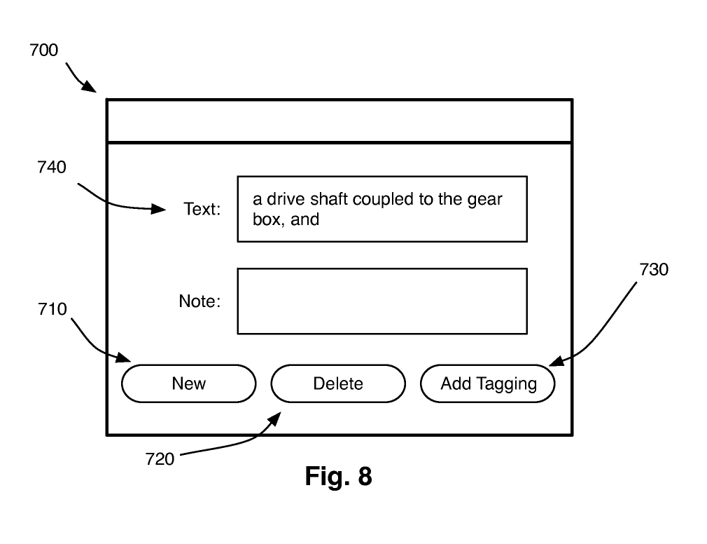

FIG. 8 shows an example of the Element Editing Pane 700. The form allows the user to edit the values of the properties of the element. The form verifies that the input is a valid value for that property. The form submits any change to the programmed processor system 4438. The programmed processor system 4438, in turn, updates the element data structure, and notifies the various document window panes of the change. The content pane 120 responds to this notification by updating the display of any changed property. For example, changes to the element text are reflected in the display of the text of the element 480 in the content pane of FIG. 5.

Tags

In the exemplary embodiment, the programmed processor system 4438 associates the document window 100 with a collection of tags. FIG. 2 shows this collection as represented in the navigation pane 110 at 220. When the tags collection is the selected navigation item, the editing pane provides a control for adding a new tag to the collection. When pressed, the button requests that the programmed processor system 4438 create a new tag and then add the new tag to the collection of tags associated with the document window 100.

In the exemplary embodiment, the programmed processor system 4438 creates a new tag by constructing a data structure in the computer memory with various properties. These properties include a unique identifier, a note, and the text of the tag. The unique identifier and note properties function for tags as described herein for patents. The text is the phrase used to represent the tag to the user.

The programmed processor system 4438 assigns default initial values to each property in the new tag data structure. These defaults suggest values a user might enter, but are intended to be replaced or customized by the user. For example, the default value of the text property is “New Tag.” However, the programmed processor system 4438 enforces a constraint on the value of the text property. No two tag data structures in a collection can have the same value for the text property. The default value, therefore, is computed based on the existing collection of tags. The programmed processor system 4438 appends numbers to the value to ensure its uniqueness. For example, three consecutively-added tags might have the text property values: “New Tag,” “New Tag 2,” and “New Tag 3.”

The programmed processor system 4438 then adds the new tag to the tag collection associated with the document window 100, and notifies the various panes of the document window of the addition. Because the tag collection contains the same kind of information, namely tags, the content pane displays a simple list of items as described above regarding FIG. 3c.

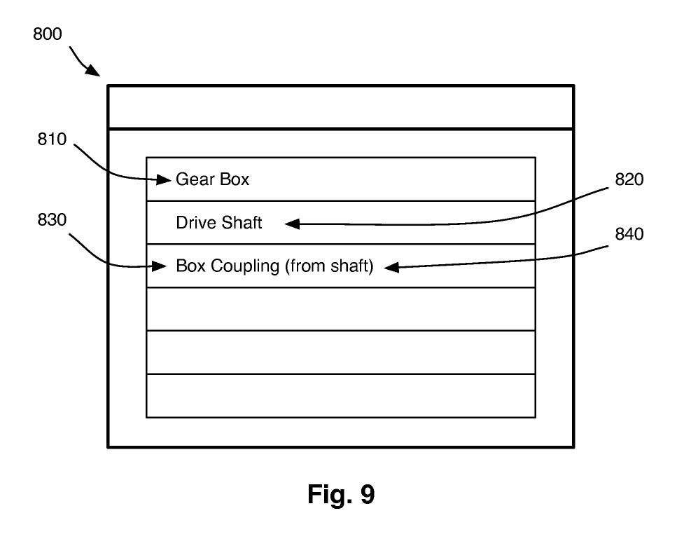

FIG. 9 shows an exemplary tags collection as represented in the content pane. Each item in the list displays the text property of a tag in the collection. If the note property has a value, that value is displayed alongside the text property. The content pane formats the note field in order to distinguish it visually from the text property. FIG. 9 shows the note property 840 separated from the text property 830 using parentheses. Other formatting, such as bold or italic font, or spacing, are additional ways to distinguish between the properties. The content pane automatically selects the first item, triggering a request that the editing pane 130 display a form for editing the values of some of the properties of the tag.

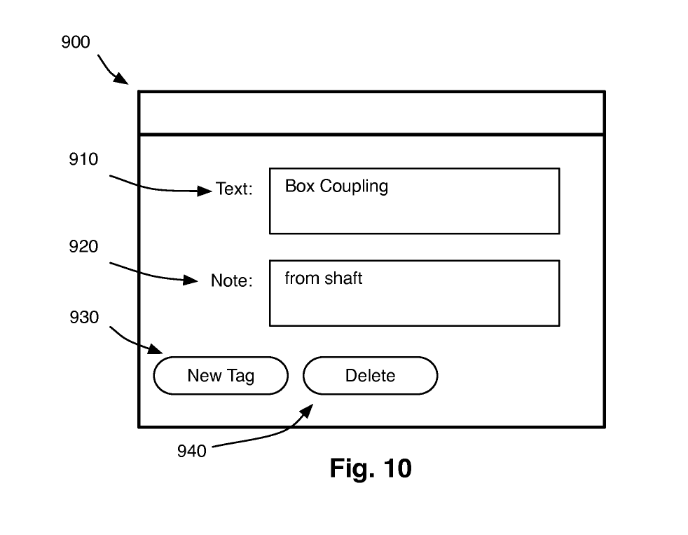

FIG. 10 shows an exemplary Tag Editing Pane 900. The form allows the user to edit the values of the properties of the tag. The form verifies that the input is a valid value for that property. For example, the text field 910 will alert the user of any entry that duplicates the value of the text property of another tag in the collection. The form submits any change to the programmed processor system 4438. The programmed processor system 4438, in turn, updates the tag data structure, and notifies the various document window panes of the change. The content pane 120 responds to this notification by updating the display of any changed property. For example, changes to the note are reflected in the display of the note 840 in the content pane of FIG. 9.

Element Tag Associations

In the exemplary embodiment, the programmed processor system 4438 associates each element with a collection of tag associations, called “taggings.” An element tagging represents the association between an element and a tag. FIG. 11 shows a first collection 1000 containing one element tagging 1010. FIG. 11 also shows a second collection 1020 containing two element taggings 1030 and 1040. The series of element tagging items is separated from the element by a visual element such as the text “Taggings:” 1000. This visual element does not appear when an element's tagging collection is empty, as shown in FIG. 11 at 460. When an element is selected in the patent content pane 400, the editing pane provides a control for adding a new element tagging to the collection. FIG. 8 shows the “Add Tagging” button 730. When pressed, the button requests that the programmed processor system 4438 create a new tagging and then add the new tagging to the collection of element taggings associated with the element. The programmed processor system 4438 creates a new tagging by constructing a data structure in the computer memory with various properties. These properties include a unique identifier, a note, and a tag. The unique identifier and note properties function for element taggings as described above for patents. The tag is a member of the collection of tags 220 discussed above.

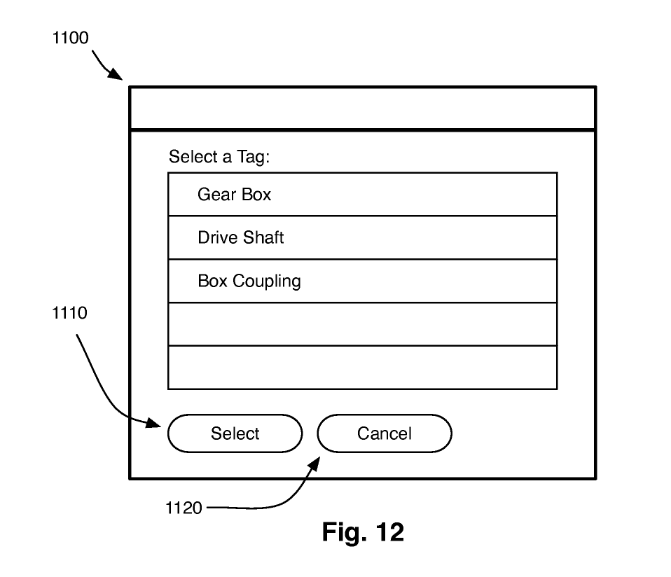

The programmed processor system 4438 assigns default initial values to certain properties in the new tagging data structure. These defaults suggest values a user might enter, but are intended to be replaced or customized by the user. The tag property, however, is chosen by the user. FIG. 12 shows an example of the Tag Selection Window 1100. The programmed processor system 4438 presents this window to the user when it assigns the initial value to the tag property. The window displays a list containing the values of the text properties of tags from the collection of tags 220. The list shows only tags that are not already present in the tagging collection for that element. The user uses the mouse 4446 or keyboard 4444 to select a tag. The user then presses the “Select” button 1110 or the “Cancel” button 1120. The “Cancel” button 1120 dismisses the window and cancels the creation of the new tagging data structure. The “Select” button 1110 dismisses the window and assigns the tag property of the new tagging data structure to the tag selected in the window.

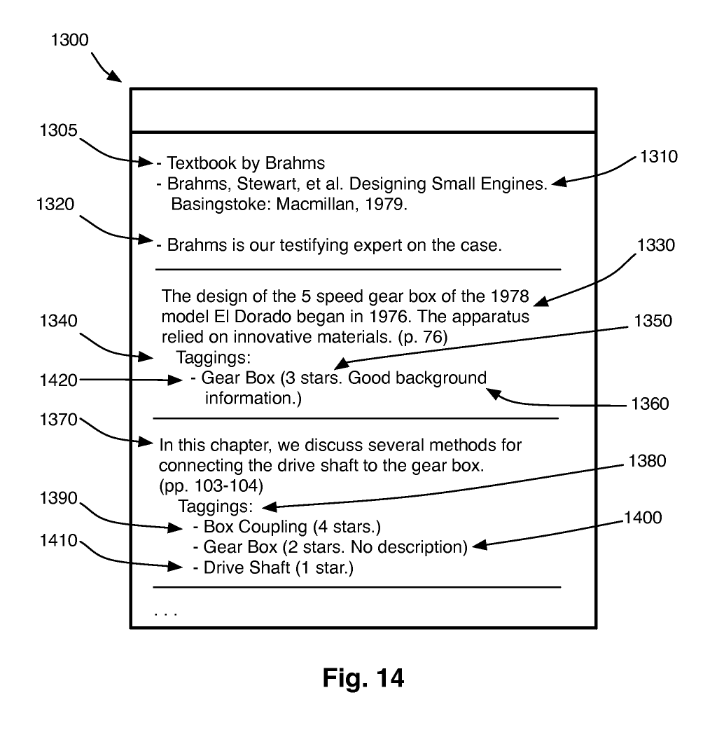

The programmed processor system 4438 then adds the new tagging to the tagging collection associated with the element, and notifies the various panes of the document window 100 of the addition. The content pane responds to this notification by inserting a new item in the list of excerpts shown in FIG. 14. If the new element tagging is the first tagging in the element tagging collection, the item appears after the item for the element. Otherwise, the item appears at the end of the existing series of tagging items. The content pane automatically selects the new item, triggering a request that the editing pane 130 display a form for editing the values of some of the properties of the tagging.

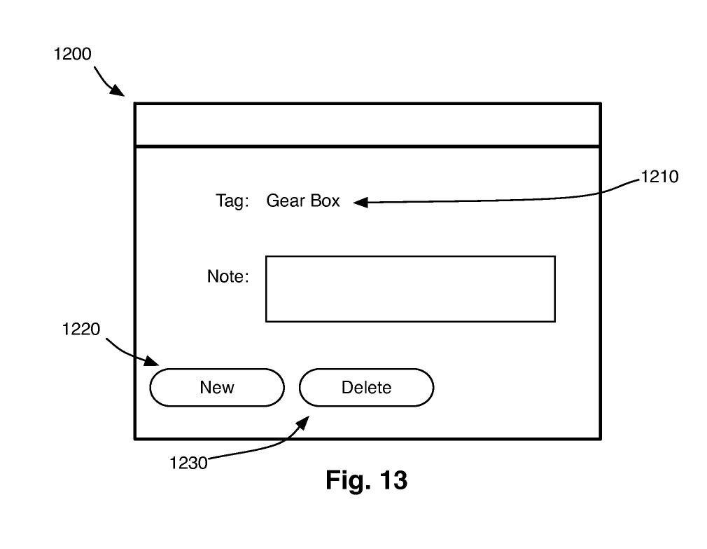

FIG. 13 shows an example of the Element Tagging Editing Pane 1200. The form allows the user to edit the values of the properties of the tagging. The form accepts user input via the keyboard or mouse. The form verifies that the input is a valid value for that property. The form submits any change to the programmed processor system 4438. The programmed processor system 4438, in turn, updates the tagging data structure, and notifies the various document window panes of the change. The content pane 120 responds to this notification by updating the display of any changed property. For example, changes to the note are reflected in the display of the note in the content pane of FIG. 5. The Element Tagging Editing Pane 1200 displays the text property 1210 of the tag object for identification purposes. However, the tag property is not editable.

### REFERENCES

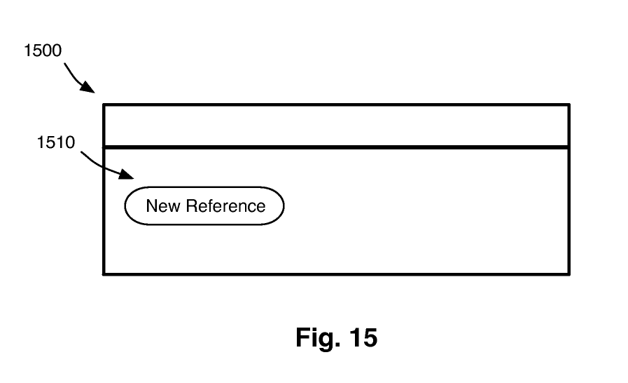

In the exemplary embodiment, the programmed processor system 4438 associates the document window 100 with a collection of references. FIG. 2 shows an example of this collection as represented in the navigation pane 110 at 230. When the reference collection is the selected navigation item, the editing pane provides a control for adding a new reference to the collection. FIG. 15 shows an example of the “New Reference” button 1510. When pressed, the button requests that the programmed processor system 4438 create a new reference and then add the new reference to the collection of references associated with the document window 100.

The programmed processor system 4438 creates a new reference by constructing a data structure in the computer memory with various properties. These properties include, for example, a unique identifier, a note, a name, a citation, and a collection of excerpts. FIG. 14 shows an example of a reference as represented in the content pane. The unique identifier and note properties function for references as described above for patents. The name is the phrase used to represent the reference to the user. As shown in FIG. 2 at 235 and in FIG. 14 at 235, the name can abbreviate the identifying features of the reference. The citation is text which fully identifies a reference. A complete citation usually includes author, title, name of article journal or book publisher, and date. Often, pages, volumes and other information will be included in a citation. A citation can be formatted according to a citation style, such as that described in the book “A Uniform System of Citation”(commonly referred to as the Bluebook), an American style guide for legal citations. FIG. 14 shows an example of a citation 1310 without formatting. The collection of excerpts 1330 and 1370 holds reference excerpts, as described in the next section.

In the exemplary embodiment, the programmed processor system 4438 assigns default initial values to each property in the new reference data structure. These defaults suggest values a user might enter, but are intended to be replaced or customized by the user. For example, the default value of the name property is “New Reference.”

The programmed processor system 4438 then adds the new reference to the reference collection associated with the document window 100, and notifies the various panes of the document window of the addition. The navigation pane 110 responds to this notification by displaying the name of the new reference as a new sub-item under the references 230 root-level item. The new sub-item is associated with the new reference. The navigation pane 110 automatically selects the new sub-item, triggering a request that the content pane 120 display the new reference. Because a reference contains several different kinds of information, the content pane displays a complex list of items as described above regarding FIG. 3c. FIG. 14 shows an example of a reference as represented in the content pane. The first item in the list displays the reference itself. The second and subsequent items in the list display the excerpts and excerpt taggings related to the reference as described in detail below. The content pane automatically selects the first item, triggering a request that the editing pane 130 display a form for editing the values of some of the properties of the reference.

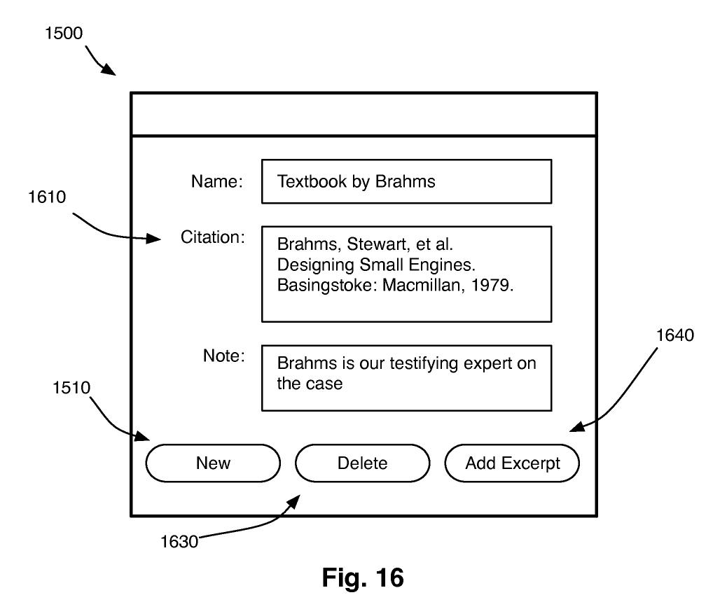

FIG. 16 shows an example of the Reference Editing Pane 1500. The form allows the user to edit the values of the properties of the reference. The form verifies that the input is a valid value for that property. For example, the citation field 1610 will prompt the user to correct any citation that does not follow the citation style. The form submits any change to the programmed processor system 4438. The programmed processor system 4438, in turn, updates the reference data structure, and notifies the various document window panes of the change. The navigation pane 110 responds to this notification if the name property has changed. The navigation pane 110 updates the text of the sub-item for the reference with the new name. The content pane 120 responds to this notification by updating the display of any changed property. For example, changes to the citation are reflected in the display of the citation 1310 in the content pane of FIG. 14.

Excerpts

In the exemplary embodiment, the programmed processor system 4438 associates each reference with a collection of excerpts. FIG. 14 shows two items 1330 and 1370 in such a collection. When a reference is selected in the content pane 120, the editing pane provides a control for adding a new excerpt to the collection. FIG. 16 shows the “Add Excerpt” button 1640. When pressed, the button requests that the programmed processor system 4438 create a new excerpt and then add the new excerpt to the collection of excerpts associated with the reference. The programmed processor system 4438 creates a new excerpt by constructing a data structure in the computer memory with various properties. These properties include a unique identifier, a note, the excerpt text, a sub-cite, and a collection of taggings. The unique identifier and note properties function for excerpts as described above for patents. The excerpt text is the text of the excerpt, as it appeared in the reference, in whole or in part. The sub-cite is an additional citation that locates the excerpt within the reference, as described in the next section. The collection of taggings holds tag associations, as described in a later section.

The programmed processor system 4438 assigns default initial values to each property in the new excerpt data structure. These defaults suggest values a user might enter, but are intended to be replaced or customized by the user. For example, the default value of the text property is “New Excerpt.”

The programmed processor system 4438 then adds the new excerpt to the excerpt collection associated with the reference, and notifies the various panes of the document window 100 of the addition. The content pane responds to this notification by inserting a new item in the list. If the new excerpt is the first excerpt in the collection, the item appears after the item for the reference. Otherwise, the item appears at the end of the existing series of excerpt items. The content pane automatically selects the new item, triggering a request that the editing pane 130 display a form for editing the values of some of the properties of the excerpt.

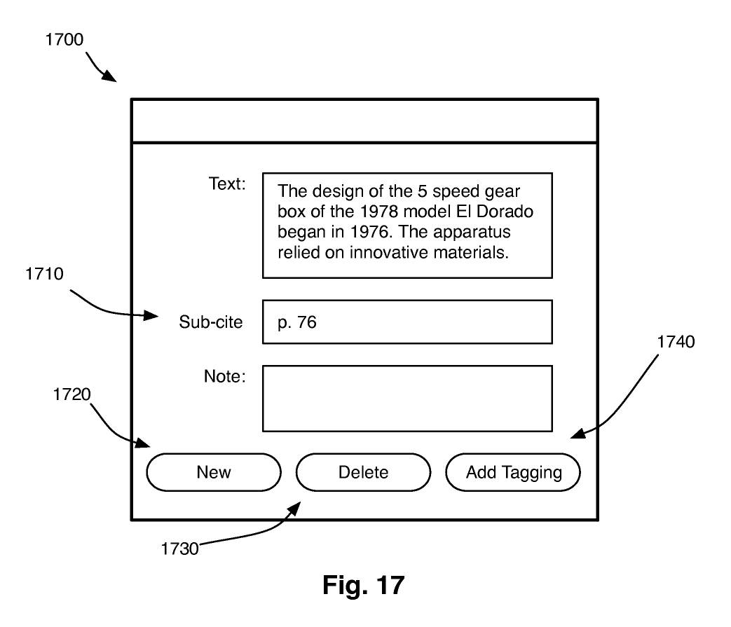

FIG. 17 shows an exemplary Excerpt Editing Pane 1700. The form allows the user to edit the values of the properties of the excerpt. The form verifies that the input is a valid value for that property. For example, the sub-cite field 1710 will prompt the user to correct any citation that does not follow the citation style. The form submits any change to the programmed processor system 4438. The programmed processor system 4438, in turn, updates the excerpt data structure, and notifies the various document window panes of the change. The content pane 120 responds to this notification by updating the display of any changed property. For example, changes to the excerpt text are reflected in the display of the text of the excerpt 1330 in the content pane of FIG. 14.

Sub-Cites

A sub-cite is an additional citation that locates an excerpt within a reference. For traditionally paginated references, a sub-cite can be a single page number or a page range. A single page number is cited as “p. 1”, “p. 100”, etc. A page range is cited as “pp. 1-2”, “pp. 356-401”, etc. For patent references, a sub-cite can be a single-column citation, a multi-column citation, a figure citation, or an abstract citation. A single-column excerpt is cited as “Col. 2:24-29”, “Col 10:1-2”, etc. A multi-column excerpt is cited as “Cols. 4:65-5:10”, “Cols. 12:50-13:19”, etc. A figure (or range of figures) is cited as “FIG. 1”, “FIGS. 3a-b”, etc. The abstract of a patent is cited as “Abstract”, “Abstract 5-12”, etc. Other sub-cites include outline-style citations such as “III.A.iii” or “3.12.1”, as well as computer source code citations like “malloc.c, line 23”. Plain text can be a sub-cite. Other sub-cites will be known to one of skill in the art.

Excerpt Tag Associations

In the exemplary embodiment, the programmed processor system 4438 associates each excerpt with a collection of tag associations, called “taggings.” An excerpt tagging represents the association between an excerpt and a tag. FIG. 14 shows an example of a first collection 1340 containing one excerpt tagging 1420. FIG. 14 also shows an example of a second collection 1380 containing three excerpt taggings: 1390, 1400, and 1410. The series of excerpt tagging items is separated from the excerpt by a visual element such as the text “Taggings:” 1340. This visual element does not appear when an excerpt's tagging collection is empty. When an excerpt is selected in the reference content pane 1300, the editing pane provides a control for adding a new tagging to the collection. FIG. 17 shows the “Add Tagging” button 1740. When pressed, the button requests that the programmed processor system 4438 create a new tagging and then add the new tagging to the collection of taggings associated with the excerpt. The programmed processor system 4438 creates a new tagging by constructing a data structure in the computer memory with various properties. These properties include a unique identifier, a note, a rating, and a tag. The unique identifier and note properties function for excerpt taggings as described above for patents. The rating is a numerical rating on a fixed scale. The rating can be, for example, a number on a scale of zero to five. The tag is a member of the collection of tags 220 discussed above.

In the exemplary embodiment, the programmed processor system 4438 assigns default initial values to certain properties in the new tagging data structure. These defaults suggest values a user might enter, but are intended to be replaced or customized by the user. The tag property, however, is chosen by the user. FIG. 12 shows an example of the Tag Selection Window 1100. The programmed processor system 4438 presents this window to the user when it assigns the initial value to the tag property. The window displays a list of the values of the text properties of tags from the collection of tags 220. The list shows only tags that are not already associated with the element in the tagging collection for that excerpt. The user interacts with the Tag Selection Window as described above regarding element tag associations.

The programmed processor system 4438 then adds the new excerpt tagging to the tagging collection associated with the excerpt, and notifies the various panes of the document window 100 of the addition. The content pane responds to this notification by inserting a new item in the list. If the new excerpt tagging is the first tagging in the tagging collection, the item appears after the item for the excerpt. Otherwise, the item appears at the end of the existing series of tagging items. The content pane automatically selects the new item, triggering a request that the editing pane 130 display a form for editing the values of some of the properties of the tagging.

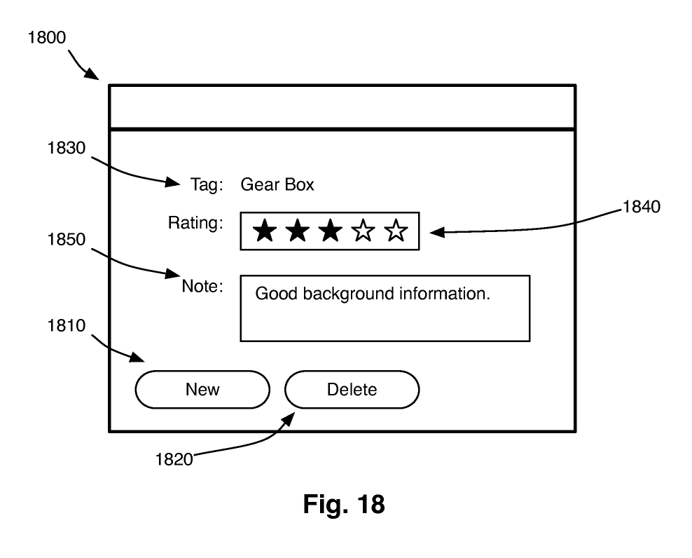

FIG. 18 shows an example of an Excerpt Tagging Editing Pane 1800. The form allows the user to edit the values of the properties of the tagging. The rating property can be represented, for example, as a horizontal series of star-shaped icons 1840. The form verifies that the input is a valid value for that property. The form submits any change to the programmed processor system 4438. The programmed processor system 4438, in turn, updates the tagging data structure, and notifies the various document window panes of the change. The content pane 120 responds to this notification by updating the display of any changed property. For example, changes to the note are reflected in the display of the note in the content pane of FIG. 14. The Excerpt Tagging Editing Pane 1800 displays the text property 1830 of the tag object for identification purposes. However, the tag property is not editable.

Combinations

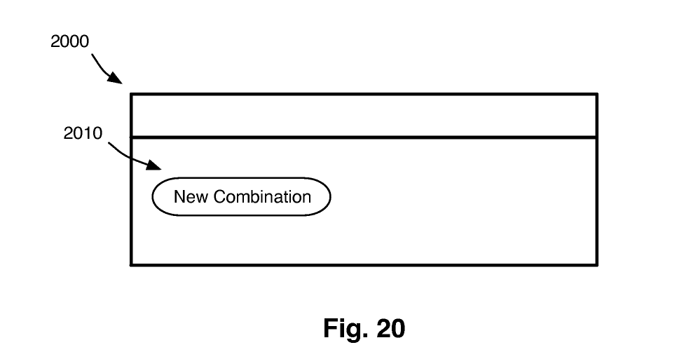

The programmed processor system 4438 associates the document window 100 with a collection of combinations. FIG. 2 shows this collection as represented in the navigation pane 110 at 240. When the combination collection is the selected navigation item, the editing pane provides a control for adding a new combination to the collection. FIG. 20 shows the “New Combination” button 2010. When pressed, the button requests that the programmed processor system 4438 create a new combination and then add the new combination to the collection of combinations associated with the document window 100.

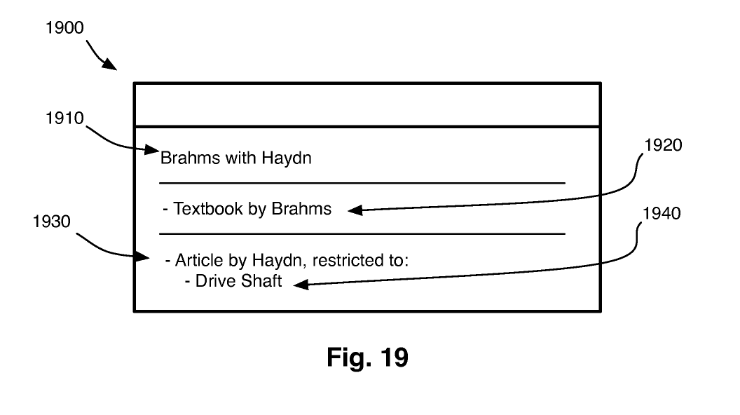

The programmed processor system 4438 creates a new combination by constructing a data structure in the computer memory with various properties. These properties include a unique identifier, a note, a name, and a collection of restricted references. FIG. 19 shows a combination as represented in the content pane. The unique identifier and note properties function for combinations as described above for patents. The name is the phrase used to represent the combination to the user. As shown in FIG. 2 at 245 and in FIG. 19 at 1910, the name can abbreviate the identifying features of the combination. The collection of restricted references 1920 and 1930 holds restricted references, as described in the next section.

The programmed processor system 4438 assigns default initial values to each property in the new combination data structure. These defaults suggest values a user might enter, but are intended to be replaced or customized by the user. For example, the default value of the name property is “New Combination.”

The programmed processor system 4438 then adds the new combination to the combination collection associated with the document window 100, and notifies the various panes of the document window of the addition. The navigation pane 110 responds to this notification by displaying the name of the new combination as a new sub-item under the combinations 240 root-level item. The new sub-item is associated with the new combination. The navigation pane 110 automatically selects the new sub-item, triggering a request that the content pane 120 display the new combination. Because a combination contains several different kinds of information, the content pane displays a complex list of items as described above regarding FIG. 3c. FIG. 19 shows an exemplary combination as represented in the content pane. The first item in the list displays the combination itself 1910. The second and subsequent items in the list display the restricted references related to the combination as described in detail below. The content pane automatically selects the first item, triggering a request that the editing pane 130 display a form for editing the values of some of the properties of the combination.

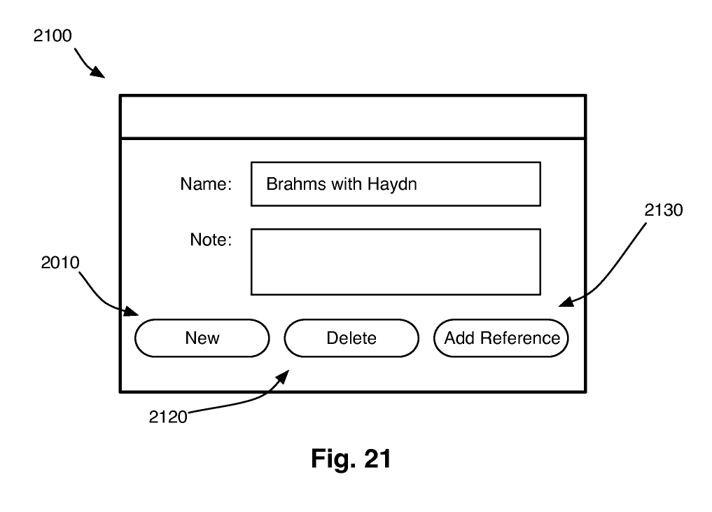

FIG. 21 shows an exemplary Combination Editing Pane 2100. The form allows the user to edit the values of the properties of the combination. The form verifies that the input is a valid value for that property. The form submits any change to the programmed processor system 4438. The programmed processor system 4438, in turn, updates the combination data structure, and notifies the various document window panes of the change. The navigation pane 110 responds to this notification if the name property has changed. The navigation pane 110 updates the text of the sub-item for the combination with the new name. The content pane 120 responds to this notification by updating the display of any changed property. For example, changes to the name are reflected in the display of the name 1910 in the content pane of FIG. 19.

Restricted References

The programmed processor system 4438 associates each combination with a collection of restricted references. FIG. 19 shows two exemplary items 1920 and 1930 in such a collection. When a combination is selected in the content pane 120, the editing pane provides a control for adding a new restricted reference to the collection. FIG. 21 shows the “Add Reference” button 2130. When pressed, the button requests that the programmed processor system 4438 create a new restricted reference and then add the new restricted reference to the collection of restricted references associated with the combination. The programmed processor system 4438 creates a new restricted reference by constructing a data structure in the computer memory with various properties. These properties include a unique identifier, a note, a reference, and a collection of tag restrictions. The unique identifier and note properties function for restricted references as described above for patents. The value of the reference property is a member of the collection of references 230 discussed above. The collection of tag restrictions is discussed below.

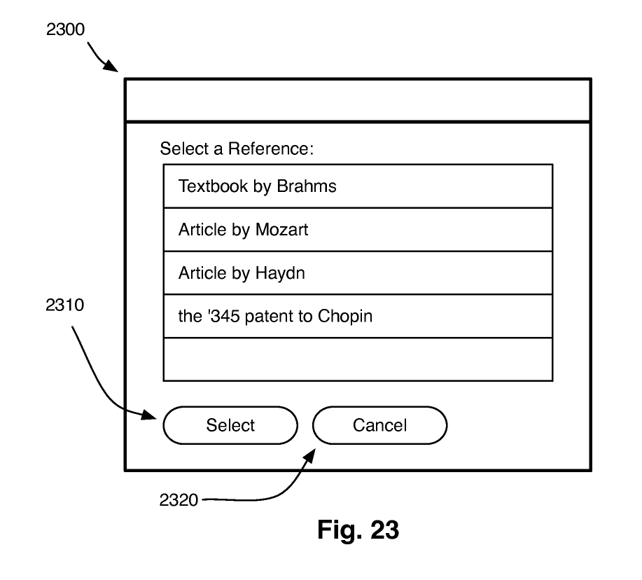

In an embodiment, the programmed processor system 4438 assigns default initial values to certain properties in the new restricted reference data structure. These defaults suggest values a user might enter, but are intended to be replaced or customized by the user. For example, the collection of tags is empty by default. The reference property, however, is chosen by the user. FIG. 23 shows an example of the Reference Selection Window 2300. The programmed processor system 4438 presents this window to the user when it assigns the initial value to the reference property. The window displays a list containing the values of the name properties of references from the collection of references 230. The list shows only references that are not already used as the reference property of an item in the restricted reference collection for that combination. The user selects a reference. The user then presses the “Select” button 2310 or the “Cancel” button 2320. The “Cancel” button 2320 dismisses the window and cancels the creation of the new restricted reference data structure. The “Select” button 2310 dismisses the window and assigns the reference property of the new restricted reference data structure to the reference selected in the window.

The programmed processor system 4438 then adds the new restricted reference to the restricted references collection associated with the combination, and notifies the various panes of the document window 100 of the addition. The content pane responds to this notification by inserting a new item in the list. If the new restricted reference is the first restricted reference in the collection, the item appears after the item for the combination. Otherwise, the item appears at the end of the existing series of restricted reference items. The content pane automatically selects the new item, triggering a request that the editing pane 130 display a form for editing the values of some of the properties of the restricted reference.

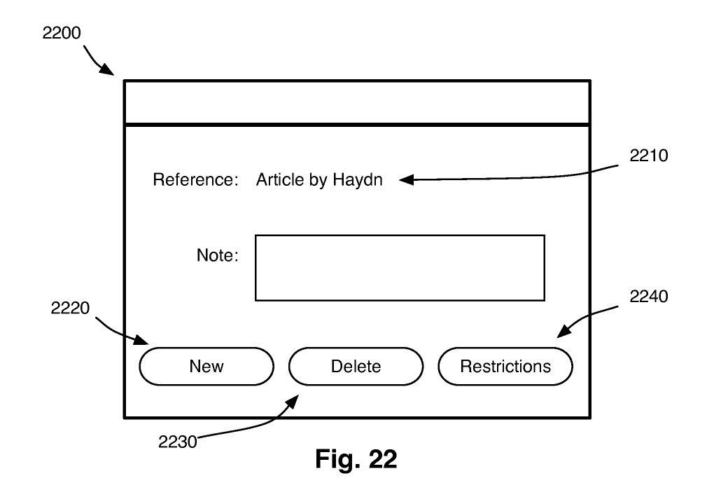

FIG. 22 shows an exemplary Restricted Reference Editing Pane 2200. The form allows the user to edit the values of the properties of the restricted reference. The form verifies that the input is a valid value for that property. The form submits any change to the programmed processor system 4438. The programmed processor system 4438, in turn, updates the restricted reference data structure, and notifies the various document window panes of the change. The content pane 120 responds to this notification by updating the display of any changed property. For example, changes to the note are reflected in the display of the note in the content pane of FIG. 19. The Restricted Reference Editing Pane 2200 displays the name 2210 of the reference for identification purposes. However, the reference property is not editable.

Tag Restrictions

The programmed processor system 4438 associates each restricted reference with a collection of tags, known as the tag restrictions. For example, FIG. 19 shows one item 1940 in such a collection. When a restricted reference is selected in the content pane 120, the editing pane provides a control for editing the tag restrictions. FIG. 22 shows the “Restrictions” button 2240. When pressed, the button requests that the programmed processor system 4438 display a window for editing the tag restrictions.

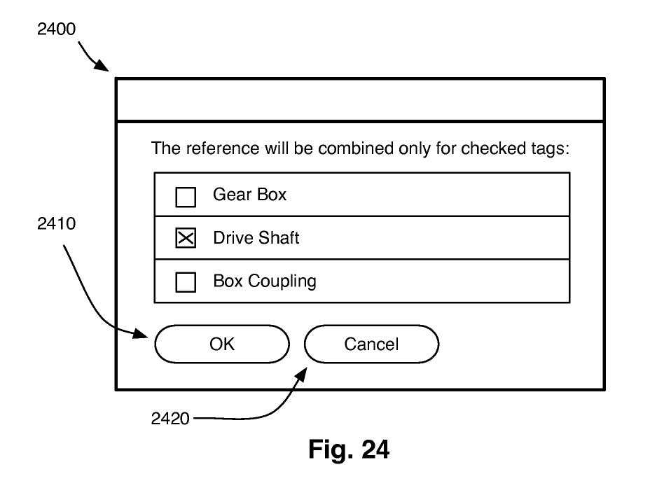

FIG. 24 shows an exemplary Tag Restrictions Window 2400. The window displays a list containing the text of each tag in the collection of tags 220 for the document window 100. The window also displays a check box next to each item in the list. When the window is first displayed, the box is checked only for those tags that are already in the tag restrictions. The user adds and removes checks via the mouse 4446 and keyboard 4444. The user then presses the “OK” button 2410 or the “Cancel” button 2420. The “Cancel” button 2420 dismisses the window and leaves the tag restrictions unchanged. The “OK” button 2410 dismisses the window and updates the tag restrictions to contain only those tags whose items were checked. The resulting collection of tags can be empty. As described in the previous section, changes to the properties of the restricted reference are reflected in the content pane. FIG. 19 shows a restricted reference 1930 with a single tag restriction 1940. The content pane indicates the existence of tag restrictions by displaying the text “restricted to:” after the name of the reference. The restrictions themselves are listed by tag text below the reference item 1930.

Reports

In the exemplary embodiment, the programmed processor system 4438 associates the document window 100 with a collection of reports. FIG. 2 represents this collection as represented in the navigation pane 110 at 250. When the reports collection is the selected navigation item, the editing pane provides a control for adding a new report to the collection. When pressed, the button requests that the programmed processor system 4438 create a new report and then add the new report to the collection of reports associated with the document window 100.

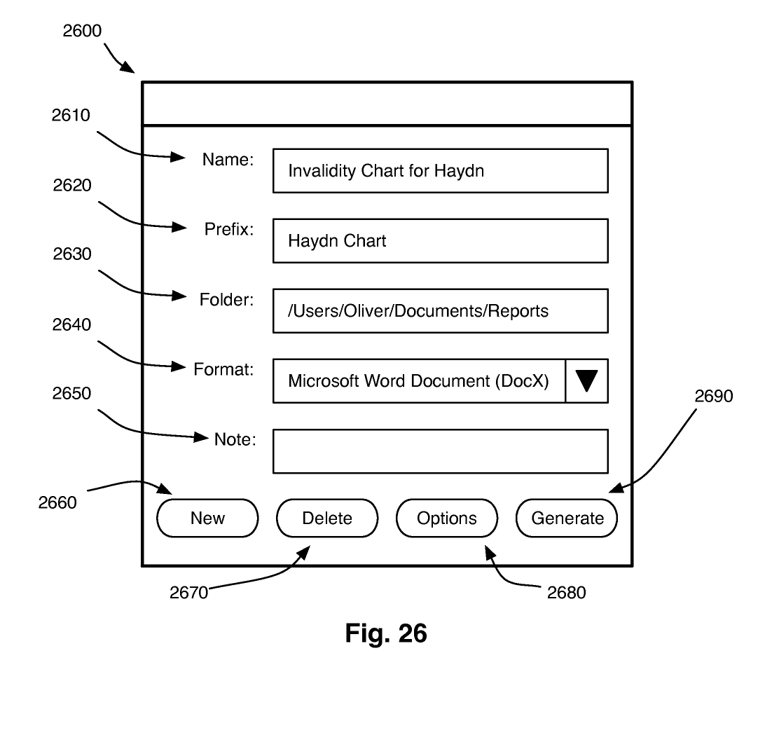

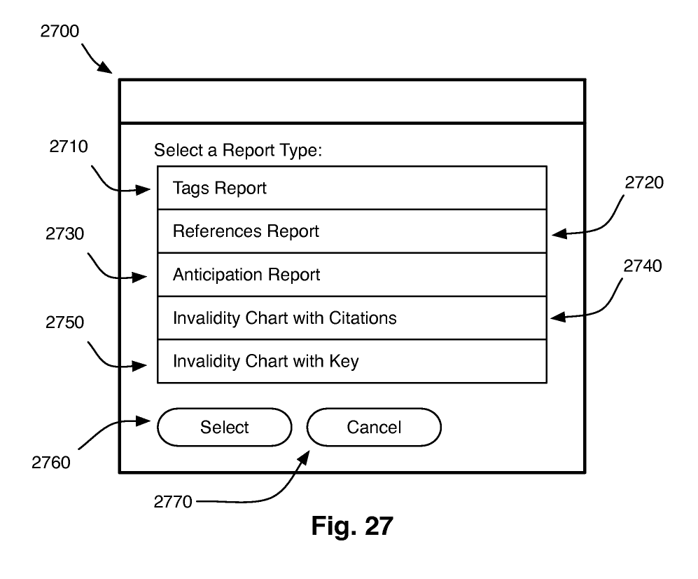

The programmed processor system 4438 presents the user with a window that lists supported report types and allows the user to choose one. FIG. 27 shows an example of the Report Type Selection Window 2700. The programmed processor system 4438 creates a new report by constructing a data structure in the computer memory with various properties. These properties, however, depend on the kind of report the user chooses. This section focuses on the properties common to all reports. Each specific kind of report will be described herein. Properties common to all reports include a unique identifier, a note, a name, a file folder, a file prefix, and the file format of the report. The unique identifier and note properties function for reports as described above for patents. The name is the phrase used to represent the report to the user. As shown in FIG. 26 at 2610, the name can abbreviate the identifying features of the report. The file folder 2630 identifies the folder in which the programmed processor system 4438 will generate files for this report. The file prefix 2620 is the prefix the programmed processor system 4438 uses when it creates a unique file name for each file it generates for the report. The file format 2640 is the format the programmed processor system 4438 uses for each generated file. The programmed processor system 4438 supports a variety of formats, including Portable Document Format (PDF), Hypertext Markup Language (HTML), Microsoft Word (DocX) format, and Microsoft Word (Doc) format. Once generated, a report file is stored in storage 4426. The file may also be printed as hard copy or transmitted via network interface 4428.

The programmed processor system 4438 assigns default initial values to each property in the new report data structure. These defaults suggest values a user might enter, but are intended to be replaced or customized by the user. For example, the default value of the format property is “Microsoft Word (DocX).”

The programmed processor system 4438 then adds the new report to the report collection associated with the document window 100, and notifies the various panes of the document window of the addition. Because the report collection contains the same kind of information, namely reports, the content pane displays a simple list of items as described above regarding FIG. 3b.

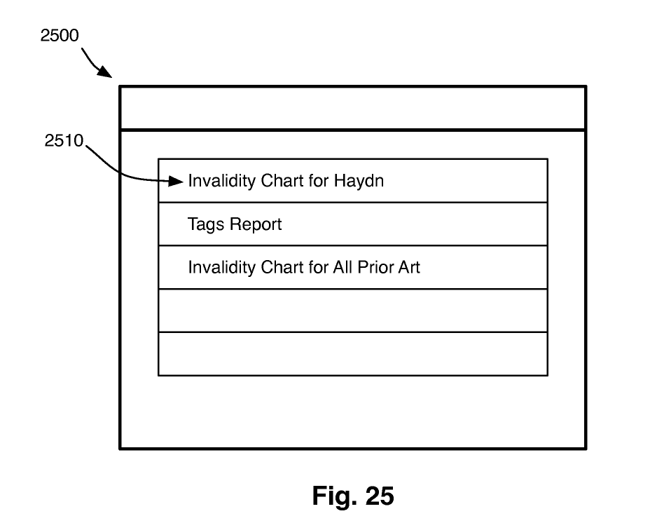

FIG. 25 shows an example of the reports collection as represented in the content pane. Each item in the list displays the name property of a report in the collection. The content pane automatically selects the first item, triggering a request that the editing pane 130 display a form for editing the values of some of the properties of the report.

FIG. 26 shows an example of the Report Editing Pane 2600. The form allows the user to edit the values of the properties of the report. The form verifies that the input is a valid value for that property. The form submits any change to the programmed processor system 4438. The programmed processor system 4438, in turn, updates the report data structure, and notifies the various document window panes of the change. The content pane 120 responds to this notification by updating the display of any changed property. For example, changes to the name are reflected in the display of the name 2510 in the content pane of FIG. 25. The “Options” button 2680 triggers the display of a window that displays options specific to the particular type of report. The “Generate” button 2690 triggers the generation of a file containing the contents of the report.

Report File Generation

In the exemplary embodiment, the programmed processor system 4438 creates report files in the folder specified by the report. Within that folder, the programmed processor system 4438 names the file using a prefix specified by the report, such as “My Report” or “Invalidity Chart,” as well as the file extension specified by the format. For example, the Portable Document Format uses the “.pdf” file extension. In addition, the programmed processor system 4438 uses a numerical counter to ensure that each file has a unique name within the folder. Some examples of file names include “My Report 001.pdf”, and “Invalidity Chart 121.docx”. The specific composition of each report is discussed in the following sections. As an alternative embodiment (not shown), a report can be presented by the programmed processor system 4438 itself, rather than relying on another application program, such as a word processor, to present the report.

Tags Report

When the programmed processor system 4438 receives a request to create a tags report via the Report Type Selection Window 2700, the programmed processor system 4438 creates a tags report data structure. The tags report data structure adds two properties to the data structure common to all reports. The patents property is a (possibly empty) collection of patents from the collection associated with the document window 100. The chart title template property contains text that the programmed processor system 4438 uses to create a title for each patent chart in the report file.

The programmed processor system 4438 assigns default initial values to each property in the new tags report data structure. These defaults suggest values a user might enter, but are intended to be replaced or customized by the user. For example, the default value of the chart title template property is “Functional tagging for the elements of % (number)s.”

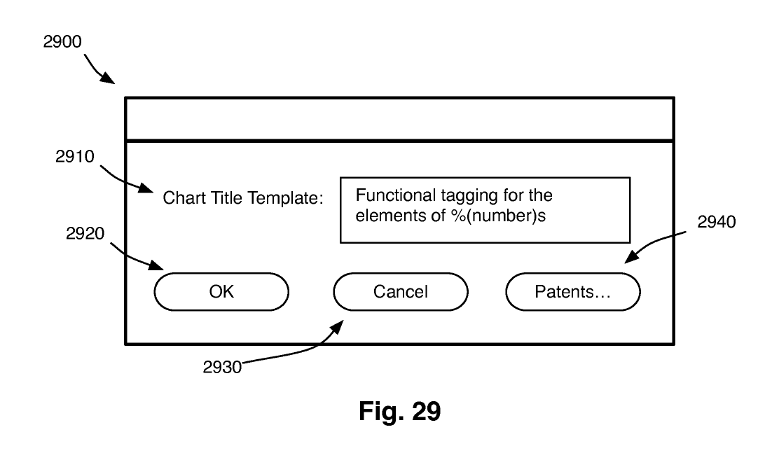

The user requests an editing window for these properties by clicking the Options button 2680 from the Report Editing Pane 2600. FIG. 29 shows an exemplary Tags Report Options Window 2900. The window allows the user to edit the values of those properties of the tags report data structure that are not common to all report types. The form verifies that the input is a valid value for that property.

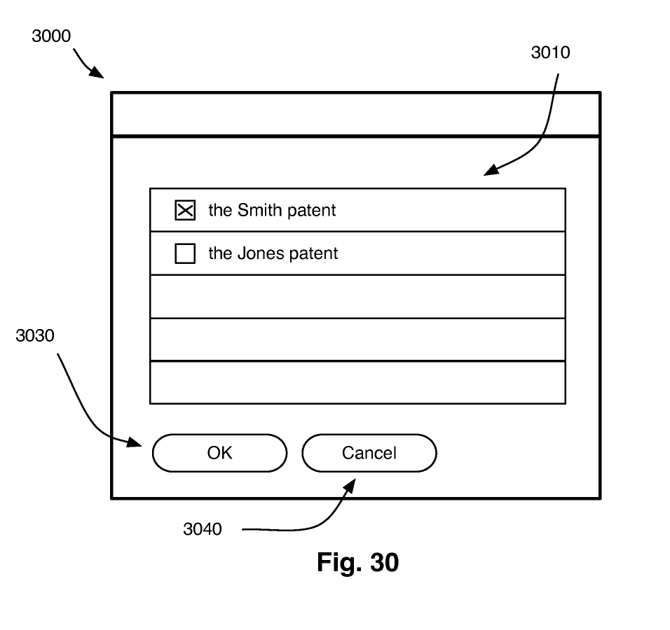

FIG. 29 shows the “Patents” button 2940. When pressed, the Patents button 2940 requests that the programmed processor system 4438 display a window for editing the collection of patents. FIG. 30 shows an example of the Patent Collection Edit Window 3000. The window displays a list 3010 containing the name of each patent in the collection of patents 210 for the document window 100. The window also displays a check box next to each item in the list. When the window is first displayed, the box is checked only for those patents that are already in the collection of patents in the patents property of the tags report data structure. The user can add and remove checks. The user then presses the “OK” button 3030 or the “Cancel” button 3040. The “Cancel” button 3040 dismisses the window and leaves the patents property unchanged. The “OK” button 3030 dismisses the window and updates the patents property to contain only those patents whose items were checked. The resulting collection of patents can be empty.

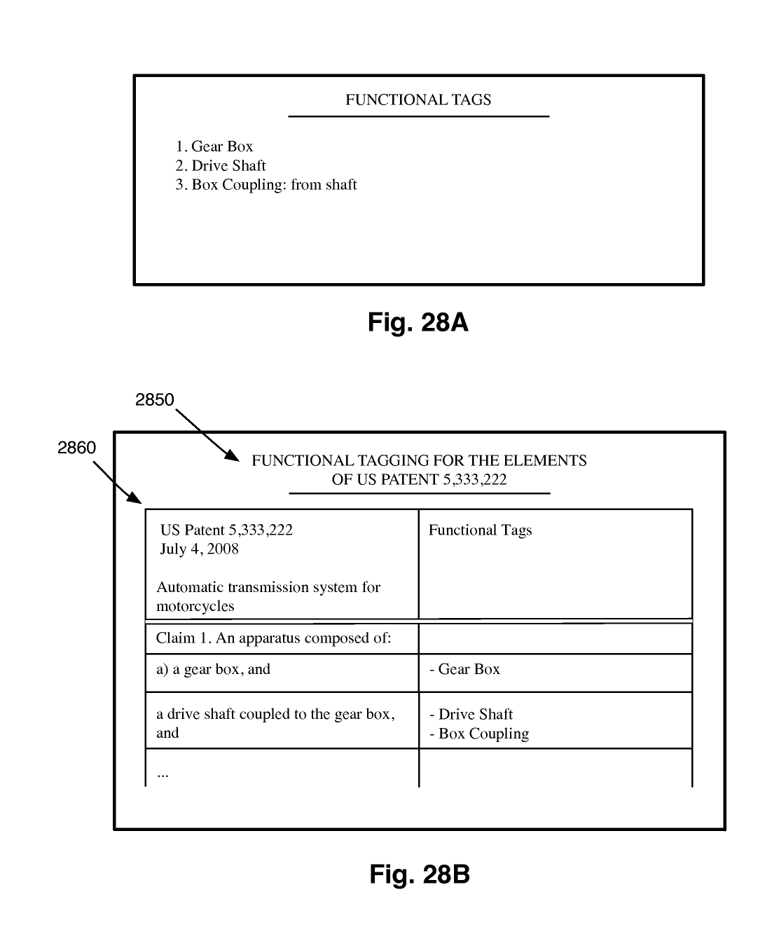

The programmed processor system 4438 uses the tags report data structure to generate a tags report file. The tags report file contains two sections: the functional tags section and the patent chart section. FIG. 28a shows the functional tags section. This section contains a numbered list of tags, identified by their tag text. If a tag has a note, the note is displayed after the tag text. All of the tags in the tags collection associated with the document window 100 appear in the list. FIG. 28b shows the patent chart section of the tags report. This section contains a chart for each patent in the patents property. If the patents property is empty, this section contains a chart for each patent in the collection of patents 210 for the document window 100. Each chart has a header 2850. The header is created using the chart title template property. The programmed processor system 4438 scans the chart title template for occurrences of replacement codes. These codes refer to properties of the patent being charted. For example, the code “% (number)s” refers to the number property of the patent. The code “% (title)s” refers to the title of the patent. The programmed processor system 4438 replaces each occurrence of a replacement code with the value of the property to which it refers. For example, when generating a chart for a patent having the number “U.S. Pat. No. 5,333,222,” it converts the template “Functional tagging for the elements of % (number)s” to “Functional tagging for the elements of U.S. Pat. No. 5,333,222.”

The chart 2860 for each patent appears below the header. Each chart has two columns. The first column contains information about the patent. The first row in the column is a header row that lists the name, issue date, and title properties of the patent. The other rows in the column contain the text of the elements of the patent. The second column contains information about the element tag associations. The first row in the column is a header row entitled “Functional Tags.” The other rows in the column contain the text of the tags associated with the element in the first column of the same row. This text is formatted as a bullet list within the chart cell. The content of the chart can also include the notes field for the patents, elements, or for the element tagging associations.

References Report

When the programmed processor system 4438 receives a request to create a References Report via the Report Type Selection Window 2700, the programmed processor system 4438 creates a references report data structure. The references report data structure adds two properties to the data structure common to all reports. The references property is a (possibly empty) collection of references from the collection associated with the document window 100. The chart title template property contains text that the programmed processor system 4438 uses to create a chart title for each reference chart in the report file.

The programmed processor system 4438 assigns default initial values to each property in the new references report data structure. These defaults suggest values a user might enter, but are intended to be replaced or customized by the user. For example, the default value of the chart title template property is “Functional tagging for % (name)s.”

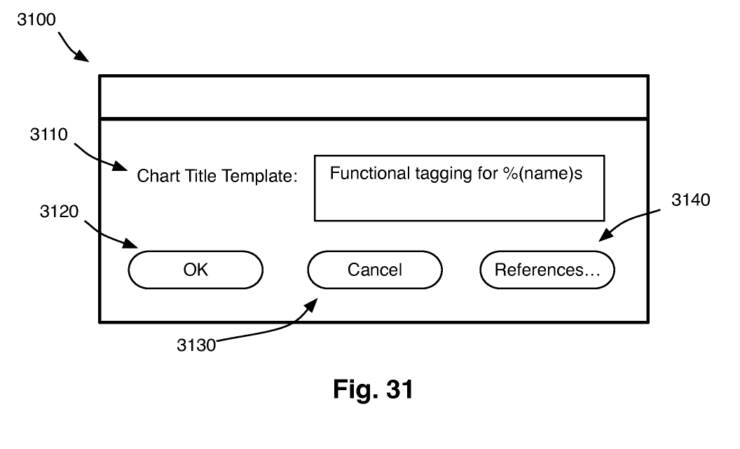

The user can request an editing window for these properties by clicking the Options button 2680 from the Report Editing Pane 2600. FIG. 31 shows an example of the References Report Options Window 3100. The window allows the user to edit the values of those properties of the references report data structure that are not common to all report types. The form verifies that the input is a valid value for that property.

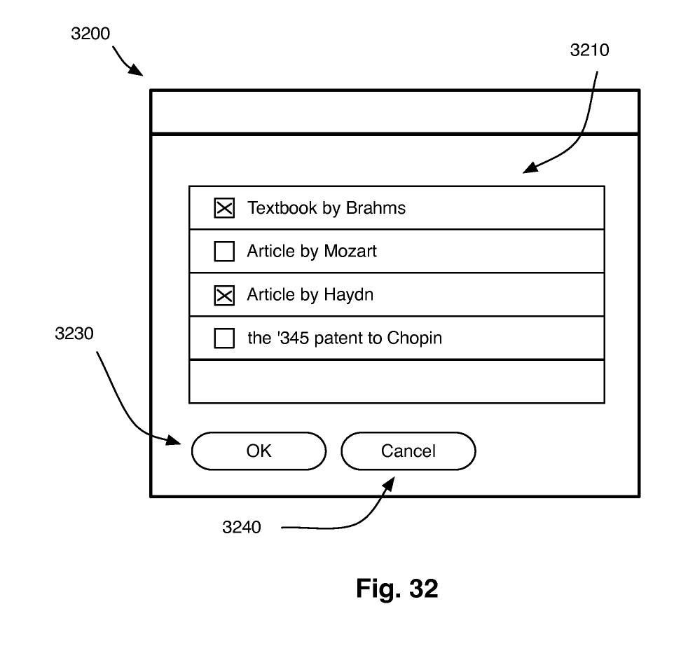

FIG. 31 shows the “References” button 3140. When the user presses the References button 3140, the programmed processor system 4438 is requested to display a window for editing the collection of references. FIG. 32 shows an example of the Reference Collection Edit Window 3200. The window displays a list containing the name of each reference in the collection of references 230 for the document window 100. The window also displays a check box next to each item in the list. When the window is first displayed, the box is checked only for those references that are already in the collection of references in the references property of the references report data structure. The user adds and removes checks. The user then presses the “OK” button 3230 or the “Cancel” button 3240. The “Cancel” button 3240 dismisses the window and leaves the references property unchanged. The “OK” button 3230 dismisses the window and updates the references property to contain only those references whose items were checked. The resulting collection of references can be empty.

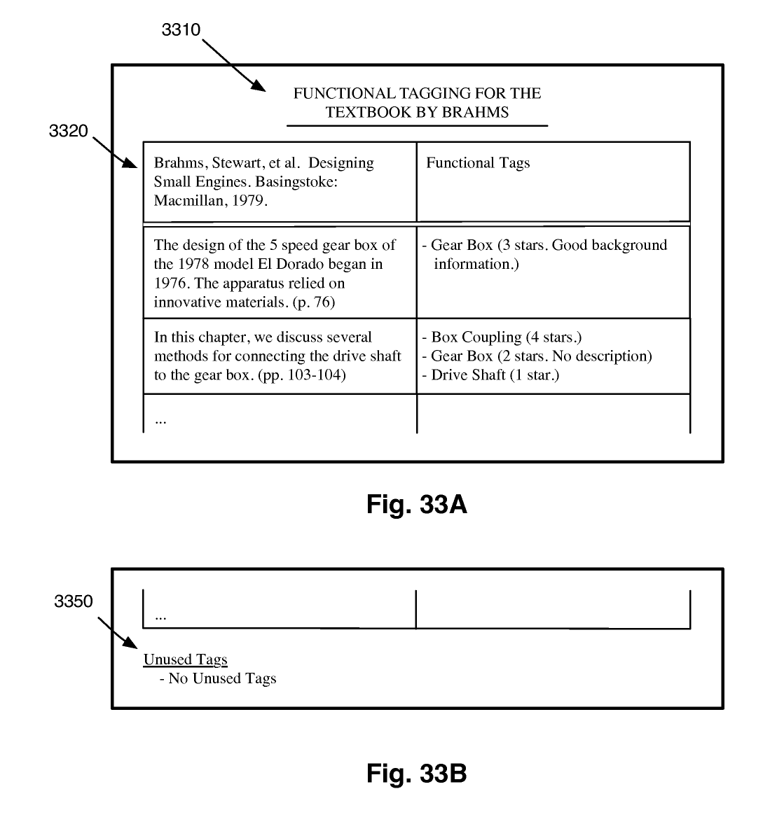

In the exemplary embodiment, the programmed processor system 4438 uses the references report data structure to generate a references report file. The references report file contains a section for each reference in the references property of the references report data structure. If the references property is empty, the file contains a section for each reference in the collection of references 230 associated with the document window 100. Each section has two parts: the tagging chart and the unused tags. FIG. 33a shows an exemplary tagging chart. The chart has a title 3310. The title is created using the chart title template property. The programmed processor system 4438 scans the chart title template for occurrences of replacement codes. These codes refer to properties of the reference being charted. For example, the code “% (name)s” refers to the name property of the reference. The programmed processor system 4438 replaces each occurrence of a replacement code with the value of the property to which it refers. For example, when generating a chart for a reference having the name “the Textbook by Brahms,” it converts the template “Functional tagging for % (name)s” to “Functional tagging for the Textbook by Brahms.” The chart for each reference appears below the header. Each chart has two columns. The first column contains information about the reference. The first row in the column is a header row 3320 that lists the citation of the reference. The other rows in the column contain the text of the excerpts from the reference. The second column contains information about the excerpt tag associations. The first row in the column is a header row entitled “Functional Tags.” The other rows in the column contain the text of the tags associated with the excerpt in the first column of the same row. This text is formatted as a bullet list within the chart cell. The content of the chart can also include the rating field for the excerpt tagging associations. The content of the chart can also include the notes field for the references, excerpts, or for the excerpt tagging associations.

FIG. 33b shows the unused tags section. This part of the report lists the text of those tags that were not used in tagging any excerpt in the reference. If every tag of the collection of tags 220 associated with the document window 100 is used to tag at least one excerpt, there are no unused tags. In that case, this part of the report reads “No unused tags.”

Anticipation Report

When the programmed processor system 4438 receives a request to create an Anticipation Report via the Report Type Selection Window 2700, the programmed processor system 4438 creates an anticipation report data structure. The anticipation report data structure adds three properties to the data structure common to all reports. The chart title template property functions for this report type as described above for the tags report. Likewise, the patents property functions for this report type as described above for the tags report. This property is editable via the equivalent of “Patents” button 2940 and Patent Collection Edit Window 3000 for the anticipation report type. The prior art property is a (possibly empty) collection of references and/or combinations from the collections of references and combinations associated with the document window 100. The minimum excerpt tagging rating property is a threshold rating value. While generating the report file, the programmed processor system 4438 ignores excerpt taggings whose rating property value is lower than this threshold.

The programmed processor system 4438 assigns default initial values to each property in the new anticipation report data structure. These defaults suggest values a user might enter, but are intended to be replaced or customized by the user. For example, the default value of the chart title template property is “Anticipation evidence for % (patent-name)s from % (prior-art-name)s”.

The user can request an editing window for these properties by clicking the Options button 2680 from the Report Editing Pane 2600.

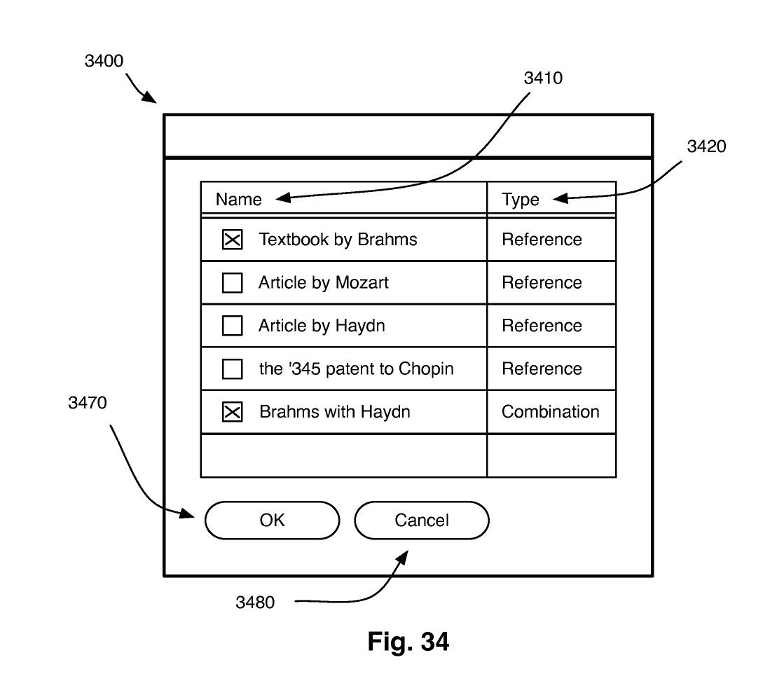

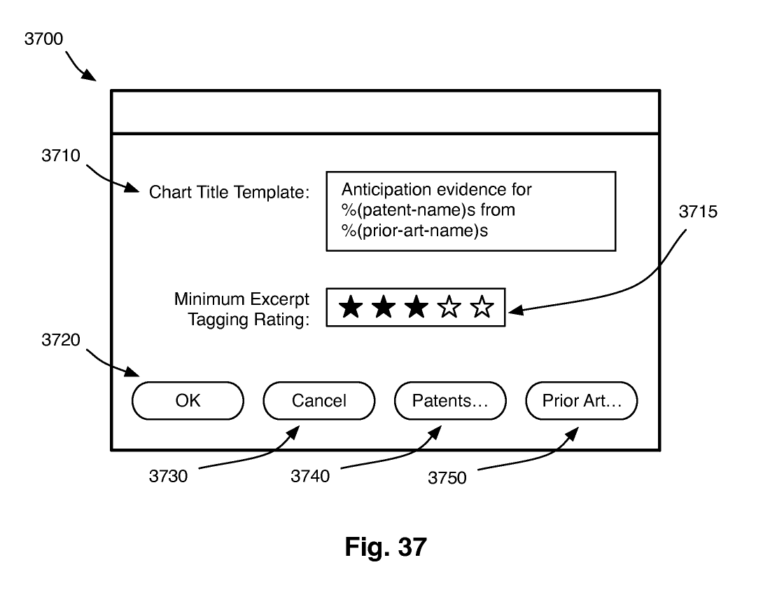

FIG. 37 shows an exemplary Anticipation Report Options Window 3700. The window allows the user to edit the values of those properties of the anticipation report data structure that are not common to all report types. The form verifies that the input is a valid value for that property. FIG. 37 shows the rating slider control for the minimum excerpt tagging rating 3715. This slider controls the value of the minimum excerpt tagging rating property. The “Patents” button 3740 presents the user with the Patent Collection Edit Window 3000 shown in FIG. 30. This window allows the user to edit the patents property in the way described above for the tags report. FIG. 37 shows the “Prior Art” button 3750. When pressed, the button requests that the programmed processor system 4438 display a window for editing the collection of prior art. FIG. 34 shows the Prior Art Collection Edit Window 3400. The window presents two different kinds of data in a single table. First, the table contains a row representing each item in the collection of references associated with the document window 100. Second, the same table also contains a row representing each item in the collection of combinations associated with the document window 100. The first row in the table is a header row. The first column in the header row bears a label 3410 “Name.” The first column of the subsequent rows displays the name property of the reference or combination item the row represents. The second column in the header row bears a label 3420 “Type.” The second column of the subsequent rows displays “Reference” if the row represents a reference item, and “Combination” if the row represents a combination item. The window also displays a check box next to each item in the list. When the window is first displayed, the box is checked only for those items that are already in the prior art property of the anticipation report data structure. The user adds and removes checks. The user then presses the “OK” button 3470 or the “Cancel” button 3480. The “Cancel” button 3480 dismisses the window and leaves the prior art property unchanged. The “OK” button 3470 dismisses the window and updates the prior art property to contain only those items whose rows were checked. The resulting collection can be empty.

In the exemplary embodiment, the programmed processor system 4438 uses the anticipation report data structure to generate an anticipation report file. The anticipation report file contains a section for each reference or combination in the prior art collection. If the prior art collection is empty, the file contains a section for every reference and combination in the respective collections associated with document window 100. A section contains a chart for each patent in the patent collection property. If the patent collection property is empty, the section contains a chart for each patent in the collection of patents associated with document window 100.

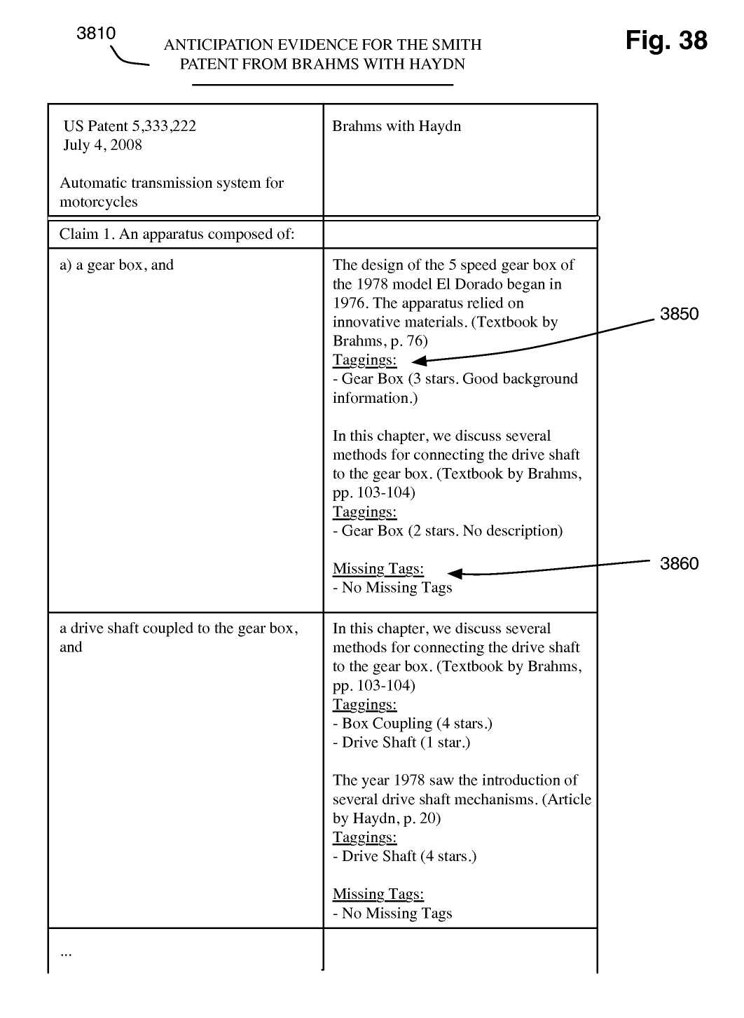

FIG. 38 shows an exemplary chart from the anticipation report file. The title 3810 is created using the chart title template property. The programmed processor system 4438 scans the chart title template for occurrences of replacement codes. These codes refer to properties of the patent or prior art being charted. For example, the code “% (patent-name)s”refers to the number property of the patent. The code “% (prior-art-name)s” refers to the name of the prior art. The programmed processor system 4438 replaces each occurrence of a replacement code with the value of the property to which it refers. For example, when generating a chart for a patent having the name “the Smith patent” and for a reference named “the Textbook by Brahms”, it converts the template “Anticipation evidence for % (patent-name)s from % (prior-art-name)s” to “Anticipation evidence for the Smith Patent from the Textbook by Brahms.”

The chart appears below the header. Each chart has two columns. The first column contains information about the patent, and is the same as the first column in the charts described above for the tags report. The second column contains information about the prior art. The first row in the column is a header row that displays the name of the prior art. The other rows in the column contain the excerpts from the prior art that are relevant to the element in the first column of the same row. Relevant excerpts are assembled using the approach described in the next section. Below each excerpt, the report file contains a list of tags that apply both to the element and to the excerpt. The rating and note properties from the excerpt tag appear alongside the association for that tag. This text is formatted as a bullet list within the chart cell.

Although not shown for purposes of clarity, an option can be included to omit the list of tags below the excerpt. The resulting report includes only the evidence, without the tagging.

Assembling Relevant Evidence

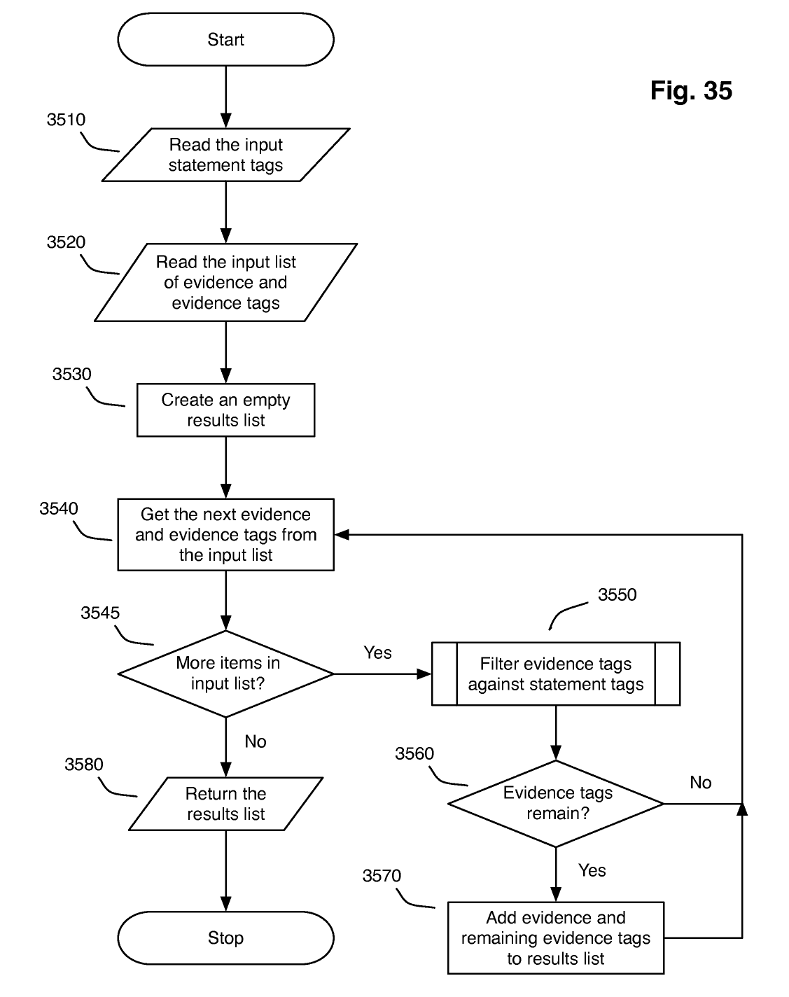

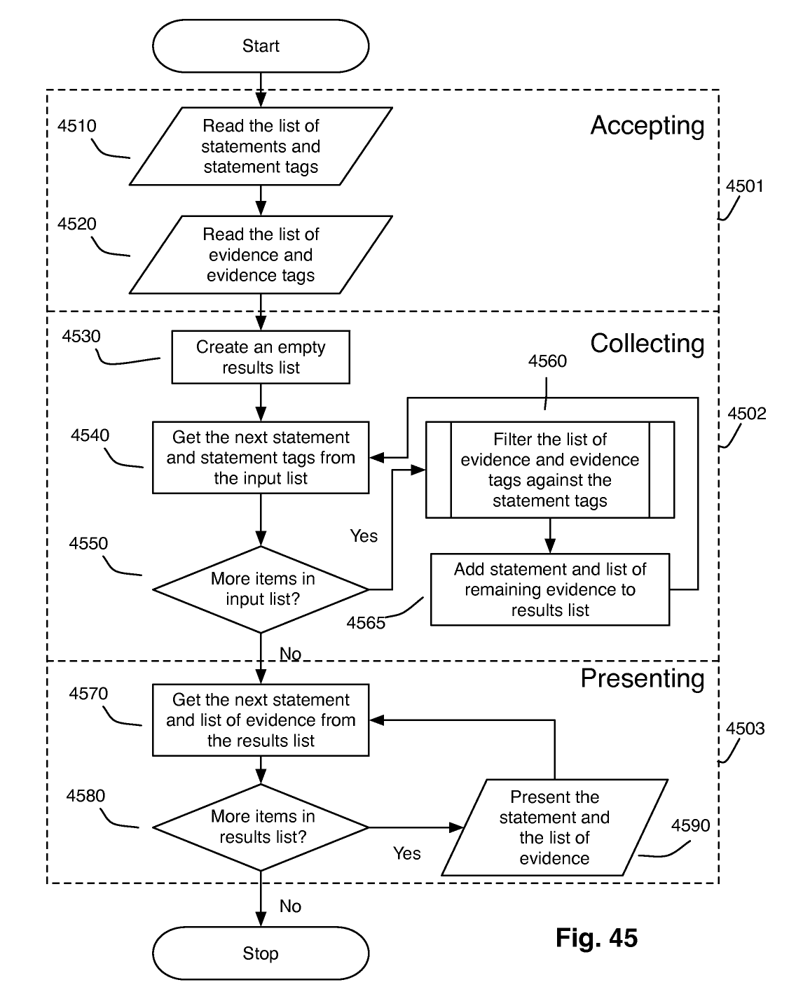

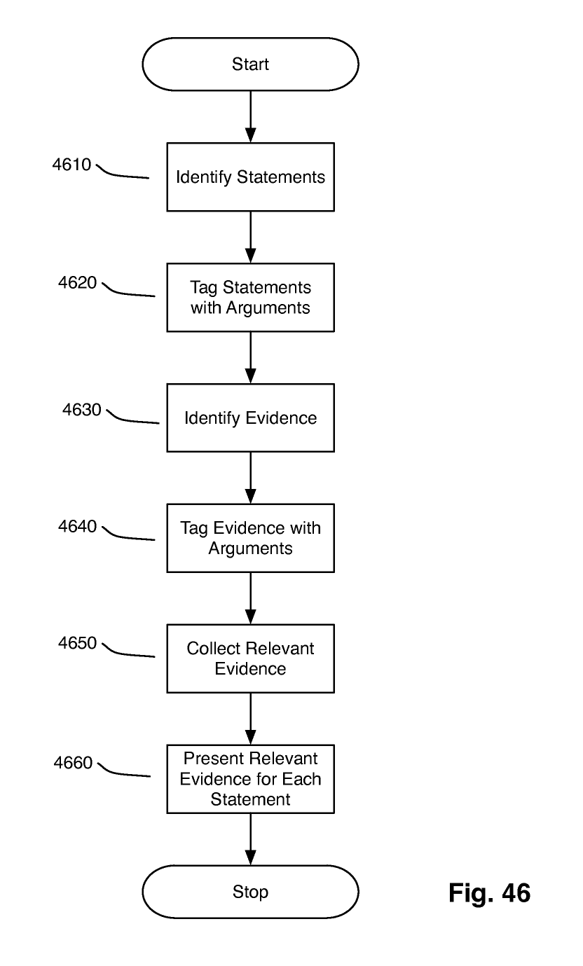

The identification of excerpts that should be charted next to an element, as well as the identification of the particular taggings that justify that charting, is a special case of a more general method. An exemplary method for assembling relevant evidence for a set of statements is illustrated by the flow diagram of FIG. 45. The figure depicts the method in three sections, the accepting section 4501, the collecting section 4502, and the presenting section 4503. It should be noted that although the operational blocks or sections shown in FIGS. 45, 35 and 36 are described below in the order in which they are shown in FIG. 46 for purposes of illustration, the operations described by the blocks or sections can occur in any suitable order with respect to each other. Similarly, the use of the term “step” or term suggesting an order (e.g., “first,” “next,” etc.) in connection with a block or operation is for purposes of illustration and is not intended to imply that steps cannot be performed in another suitable order. Furthermore, the operations described by one block can overlap or be combined with those described by other blocks in other embodiments of the invention.

In the accepting section 4501, the approach accepts as input a list of statements and statement tags. Each item in this list is composed of a statement and a list of statement tags. A statement tag is a tag that is associated with a statement. The method also accepts as input a list of evidence and evidence tags. Each item in this list is composed of an evidence item and a list of evidence tags. An evidence tag is a tag associated with an evidence item. These two inputs are read in the first step 4510 and the second step 4520 of the process. This accepting may occur in variety of ways known to those of skill in the art, including, but not limited to, keyboard entry, mouse input, and transmission over a network. Accepting also includes receiving information passed from one software module to another. The output of the collecting section 4502 is another list of statements and evidence lists. Each item in this list is composed of a statement and a list of evidence items. This list, called the results list, is created in the next step 4530. Initially, the results list is empty. The approach examines each item in the list of statements and statement tags in order. The list of evidence and evidence tags is filtered against the list of statement tags under examination in the step labeled 4560. The filter yields a list of remaining evidence items and evidence tags. This filtering approach is described in more detail in the next paragraph. The statement under examination and the remaining evidence items are appended to the results list in step 4565. In the presenting section 4503, the approach examines in step 4570 each item in the results list in order and presents in step 4590 each statement and list of evidence items under examination. This presentation may occur in variety of ways known to those of skill in the art, including, but not limited to, screen display, hard copy, and transmission over a network. Presentation also includes arranging the results of the approach in a particular format that may be displayed by another program, for example, in Microsoft Word or HTML format.

FIG. 35 shows step 4560 in further detail. The exemplary method illustrated by the flow diagram of FIG. 35 accepts as input a collection of statement tags. The method also accepts as input a list of evidence and evidence tags. Each item in this list is composed of an evidence item and a list of evidence tags. These two inputs are read in the first step 3510 and the second step 3520 of the method. The output of the approach is another list of evidence and evidence tags. This list, called the results list, is created in the next step 3530. Initially, the results list is empty. The method examines each item in the list of evidence and evidence tags in order. The collection of evidence tags under examination is filtered against the collection of statement tags in the step labeled 3550. The filter yields another collection of evidence tags containing only those evidence tags that were also present in the statement tags. This filtering approach is described in more detail in the next paragraph. The next step 3560 checks if any evidence tags remain after the filtering process. If not, then the evidence is not relevant to the statement according to this approach, and is ignored. If evidence tags remain after filtering, the evidence item and the remaining tags are appended to the results list in step 3570. The method finishes by returning the results list 3580, which now contains each relevant evidence item, alongside those tags that make that evidence item relevant. This approach ensures that evidence items appear in the results list in the same order they appear in the input. Although in the exemplary embodiment of the invention step 4560 (FIG. 45), in which the list of evidence and evidence tags is filtered, can comprise the sub-steps described above with regard to FIG. 35, in other embodiments filtering of the list of evidence and evidence tags can be performed in any other suitable manner.

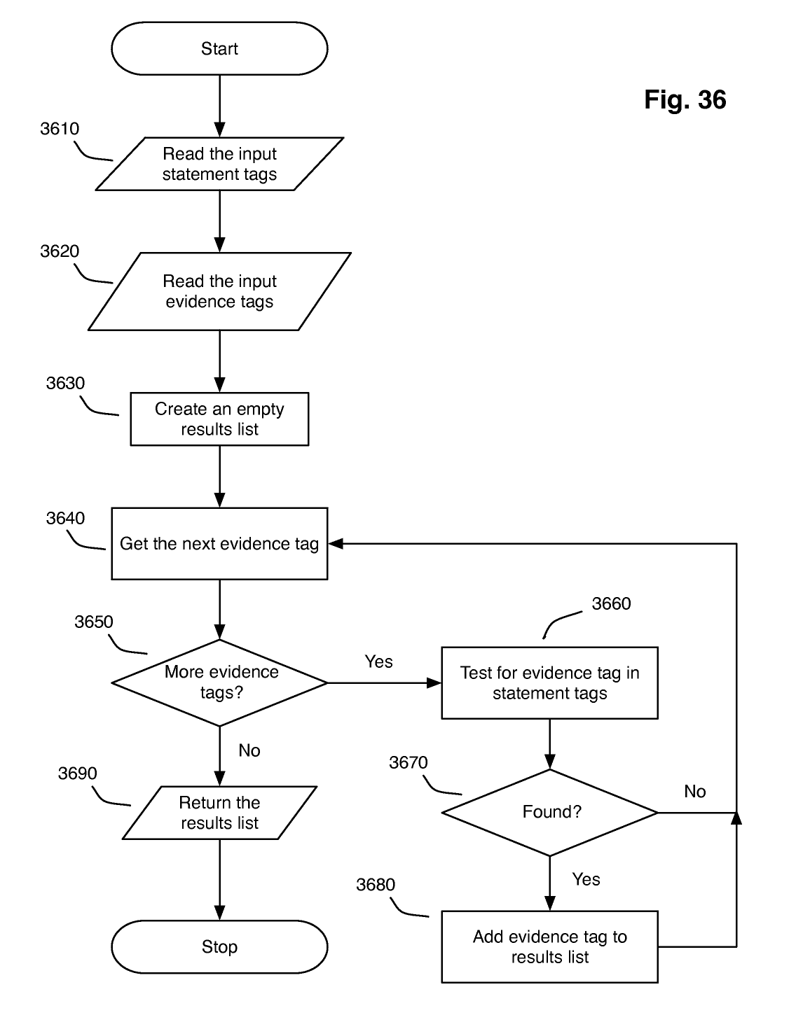

FIG. 36 shows step 3550 (FIG. 35) in further detail. The exemplary method illustrated by the flow diagram of FIG. 36 accepts as input a collection of tags associated with a statement, or statement tags. The method also accepts as input a list of tags associated with an evidence item, or evidence tags. These two inputs are read in the first step 3610 and the second step 3620 of the method. The output of the method is another list of evidence tags. This list, called the results list, is created in the next step 3630. Initially, the results list is empty. The method examines each evidence tag in order. In step 3660, the approach tests each evidence tag to determine whether the tag is present among the statement tags. If the tag is among the statement tags, the tag is added to the results list in step 3680. The result is a collection of evidence tags containing all of the evidence tags that were also present in the statement tags. The method finishes by returning the results list 3690, which now contains the tags that make the evidence item relevant to the statement. This method ensures that evidence tags appear in the results list in the same order they appear in the input. Although in the exemplary embodiment of the invention step 3550 (FIG. 35), in which the collection of evidence tags is filtered, can comprise the sub-steps described above with regard to FIG. 36, in other embodiments filtering of the evidence tags can be performed in any other suitable manner.

In the exemplary embodiment, the programmed processor system 4438 effects the method shown in FIGS. 35-36 to generate an anticipation report chart as follows. Each chart row shows an element of the charted patent. The programmed processor system 4438 treats the element as the “statement” for the purpose of the above approach. The programmed processor system 4438 collects the tag property from each tagging in the element's collection of element tag associations. This collection becomes the input statement tags read in the first step 3510 of the approach. The programmed processor system 4438 also processes the charted prior art to create the list of evidence and evidence tags read in the second step 3520.

If the prior art is a reference, the programmed processor system 4438 treats the excerpts collected in the excerpts property of the reference as the “evidence” for the purpose of the above approach. The programmed processor system 4438 assembles a collection of evidence tags for each excerpt. First, the programmed processor system 4438 examines each excerpt tagging in the excerpt's taggings property. If the value of the tagging's rating property meets the minimum rating specified in the report data structure, the programmed processor system 4438 then adds the value of the tag property to the collection of evidence tags. This collection, along with the excerpt itself, is appended to a list of evidence and evidence tags, which the programmed processor system 4438 uses as the second input to the approach. This list contains an item for each excerpt in the reference.

If the prior art is a combination, the programmed processor system 4438 uses a more complex method for creating the input list of evidence and evidence tags. The combination has a collection of several restricted references. The input list of evidence and evidence tags contains excerpts from each of these. The programmed processor system 4438 examines each restricted reference in order. Each restricted reference has a tag restrictions property. If the tag restrictions are empty, the programmed processor system 4438 reads the reference property of the restricted reference and generates an input list for the reference as described above for references. If the tag restrictions are not empty, the programmed processor system 4438 reads the reference property, but alters the process used for references. After collecting the evidence tags for an excerpt, the programmed processor system 4438 removes from the collection any evidence tag that is not also found in the tag restrictions. The resulting collection is thereby filtered to include only the tags to which that reference is restricted. After processing each restricted reference, the programmed processor system 4438 appends the list of evidence and evidence tags for that restricted reference to a master list for the entire combination, which the programmed processor system 4438 uses as the second input to the approach. This list contains an item for each excerpt in each reference in the combination.

After assembling the inputs, the programmed processor system 4438 effects the method shown in FIG. 35 and FIG. 36 to create the resulting list of evidence and evidence tags. The programmed processor system 4438 uses the result of the approach to create the contents of the second column of the report row. The results list returned in step 3580 contains only the excerpts relevant to the element. These are the excerpts displayed in the chart cell. The programmed processor system 4438 uses the tags returned with the excerpt in the results list to find the taggings that associate each of those tags with the excerpt. These taggings contain the rating and note properties displayed alongside the tag in the chart at 3850.

At the bottom of the second column of the report row, the programmed processor system 4438 lists the element tags that were not returned with any relevant excerpt. This list of missing tags 3860 is shown in FIG. 38, and may be empty.

Invalidity Chart with Citations Report

When the programmed processor system 4438 receives a request to create an Invalidity Chart with Citations (ICC) via the Report Type Selection Window 2700, the programmed processor system 4438 creates a ICC report data structure. The ICC report data structure has all of the properties of the anticipation report data structure, plus the starting exhibit letter property. An exhibit letter is a letter code common in legal documents. As a group, exhibit letters are a series of one or two letter codes. The first exhibit letter is “A”. After the final single-letter code, “Z”, the next code is “AA.” “AA” is followed by “AB”, “AZ” is followed by “BA”, and so on. The last exhibit letter is “ZZ”.

The programmed processor system 4438 assigns default initial values to each property in the new ICC report data structure. These defaults suggest values a user might enter, but are intended to be replaced or customized by the user. For example, the default value of the chart title template property is “Disclosure of invalidity contentions for % (patent-number)s.” The default value for the starting exhibit letter is “A.”

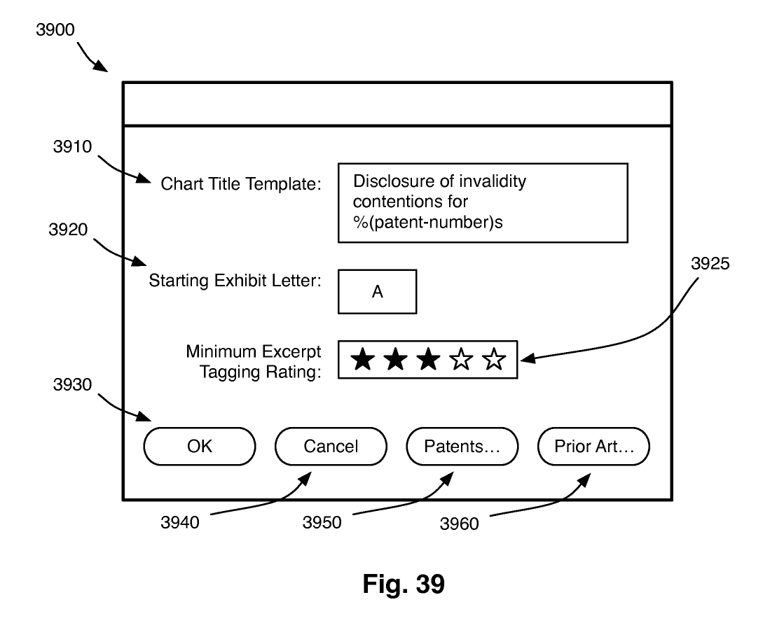

The user can request an editing window for these properties by clicking the Options button 2680 from the Report Editing Pane 2600. FIG. 39 shows an exemplary Invalidity Contentions with Citations Report Options (ICCRCO) Window 3900. The ICCRCO window 3900 allows the user to edit the values of those properties of the ICC report data structure that are not common to all report types. The form verifies that the input is a valid value for that property. FIG. 39 shows the “Chart Title Template” field 3910, the “Patents” button 3950, and the “Prior Art” button 3960. These controls function in the same way for the ICC report as they do for the invalidity report.

The programmed processor system 4438 uses the ICC report data structure to generate an ICC report file. The ICC report file contains a section for each patent in the patent collection property. If the patent collection property is empty, the file contains a section for each patent in the collection of patents associated with document window 100.

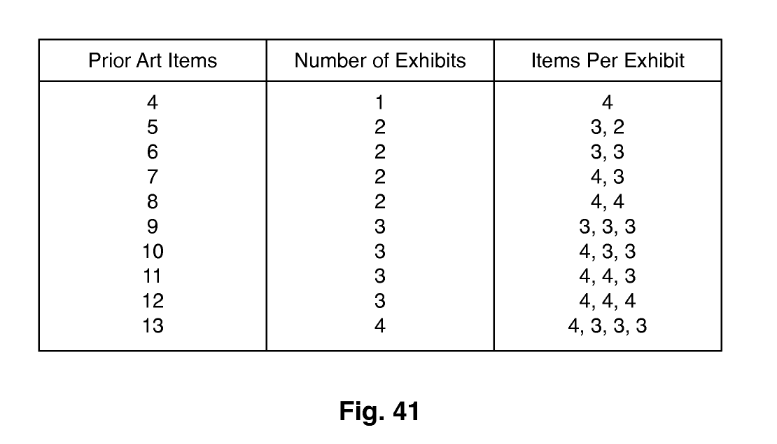

Each section contains at least one exhibit. The number of exhibits in a section depends on the number of prior art items to be charted. A single exhibit charts, for example, one, two, three, or four prior art items. In the exemplary embodiment, a section charting more than four prior art items requires more than one exhibit. Prior art items can be grouped into exhibits according to, for example, three rules. First, no group can contain more than four items. Second, the minimum number of groups is used. Third, the largest group can have, at most, one more item than the smallest group. FIG. 41 shows groupings valid under these rules for a range of item counts.

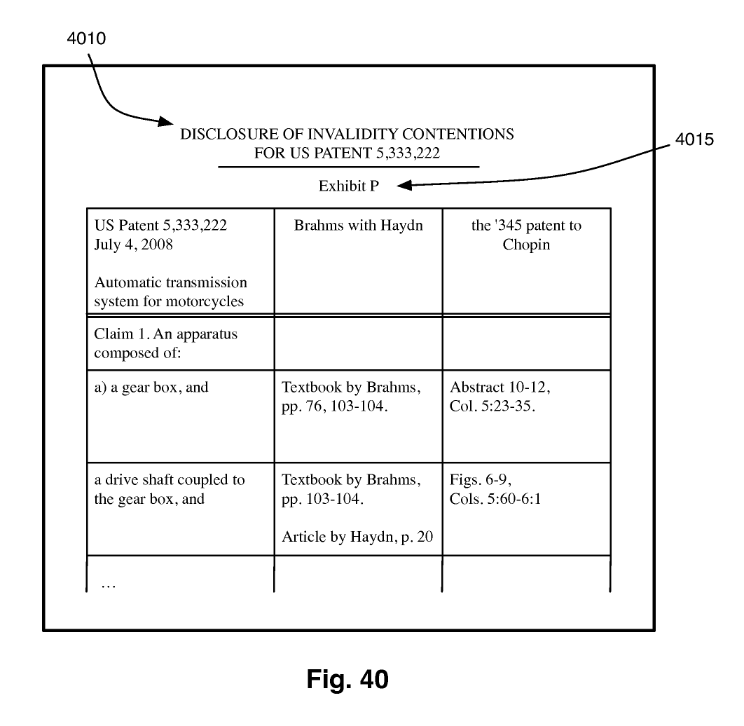

Each exhibit is assigned a letter code, starting with the value of the starting exhibit letter property, and continuing through the series as described above. Each exhibit begins with a separator page bearing the text “Exhibit A”, where A is replaced by the current exhibit letter. Each exhibit contains a chart after the separator page. FIG. 40 shows a chart. Each chart has a header. The header begins with the chart title 4010, created using the chart title template property. The programmed processor system 4438 scans the chart title template for occurrences of replacement codes. These codes refer to properties of the patent being charted. For example, the code “% (number)s” refers to the number property of the patent. The programmed processor system 4438 replaces each occurrence of a replacement code with the value of the property to which it refers. For example, when generating a chart for a patent having the number “U.S. Pat. No. 5,333,222,” it converts the template “Disclosure of invalidity contentions for % (number)s” to “Disclosure of invalidity contentions for U.S. Pat. No. 5,333,222.” The header continues with a sub-heading “Exhibit A” 4015, where “A” is replaced by the current exhibit number.

Each chart has a patent column followed by a prior art column for each prior art item in the group for the current exhibit. The patent column contains information about the patent, and is the same as the first column in the charts described above for the invalidity report. Each prior art column contains information about a prior art item. The first row in the column is a header row with the name of the prior art item. The other rows in the column contain a list of citations to the excerpts from the prior art that are relevant to the element in the first column of the same row. Relevant excerpts are assembled using the same approach used for the anticipation report. The list of citations is assembled from the relevant excerpt data structures using the approach described in the next section.

Assembling Citation Lists

In the exemplary embodiment, the programmed processor system 4438 assembles a citation list from a collection of excerpts in several steps. First, the programmed processor system 4438 groups the excerpts according to the kind of citation found in their sub-cite property. For example, for a prior art reference that is itself a patent, all citations to the abstract would be grouped together, all citations to figures would be grouped together, all column cites would be grouped together, and so on. Next, the programmed processor system 4438 sorts the items in each group according to the order they appear in the actual reference, not necessarily the order the items appear in the excerpts collection. For example, page number and page range citations sort by their first page from lowest to highest. Patent column citations sort by starting column and line number from lowest to highest. Next, the programmed processor system 4438 moves through the sorted items and combines adjacent items to produce a more concise citation. Items are combined for in at least three ways. First, identical items are combined. For example, two or more excerpts from page 22 of a reference can be combined into a single sub-cite: “p. 22.” Second, adjacent or overlapping items are combined. The three sub-cites “Col. 5:10-20,” “Col. 5:21-30,” and “Col. 5:25-44” are combined to “Col. 5:10-44.” Third, items of the same type are combined to their most compact representation. For example, the three sub-cites “FIG. 23,” “FIGS. 26-31,” and “FIG. 70” are combined to “FIGS. 23, 26-31, and 70.” If the prior art is a combination, the programmed processor system 4438 uses this method to assemble a citation list for each restricted reference, and adds the reference name to identify each non-empty list.

Invalidity Chart with Key Report

When the programmed processor system 4438 receives a request to create an Invalidity Chart with Key (ICK) report via the Report Type Selection Window 2700, the programmed processor system 4438 creates an ICK report data structure. The ICK report data structure has all of the properties of the Invalidity Chart with Citations (ICC) report data structure, plus the key title template property. The key title template property contains text that the programmed processor system 4438 uses to create a title for the key section in the report file.

The programmed processor system 4438 assigns default initial values to each property in the new ICK report data structure. These defaults suggest values a user might enter, but are intended to be replaced or customized by the user. For example, the default value of the key title template property is “Key to % (exhibitRange)s of the disclosure.”

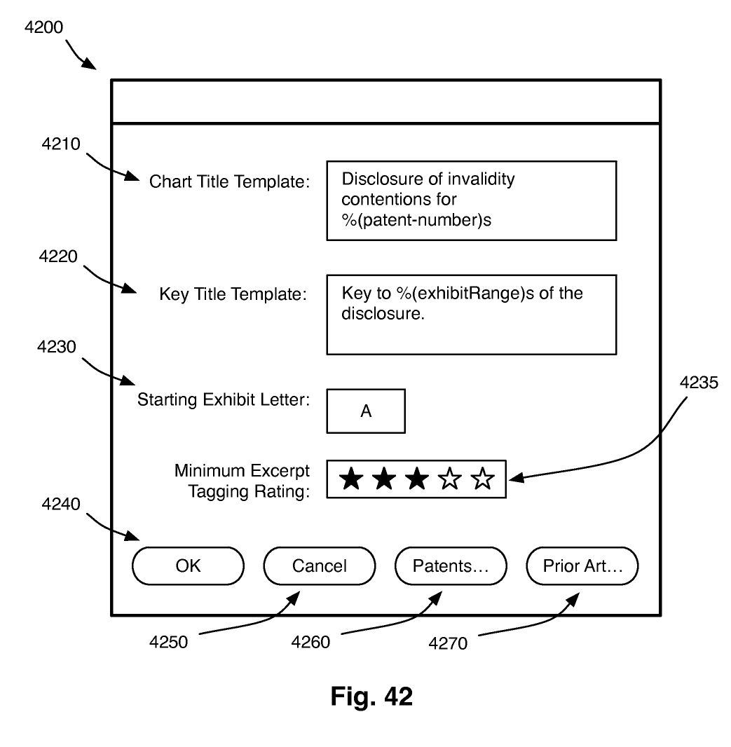

The user requests an editing window for these properties by clicking the Options button 2680 from the Report Editing Pane 2600. FIG. 42 shows an exemplary Invalidity Contentions with Key Report Options Window 4200. The window allows the user to edit the values of those properties of the ICK report data structure that are not common to all report types. The form verifies that the input is a valid value for that property. FIG. 42 shows the “Chart Title Template” field 4210, the “Starting Exhibit Letter” field 4230, the “Patents” button 4260, and the “Prior Art” button 4270. These controls function in the same way for the ICK report as the corresponding controls shown in FIG. 39 function for the ICC report.

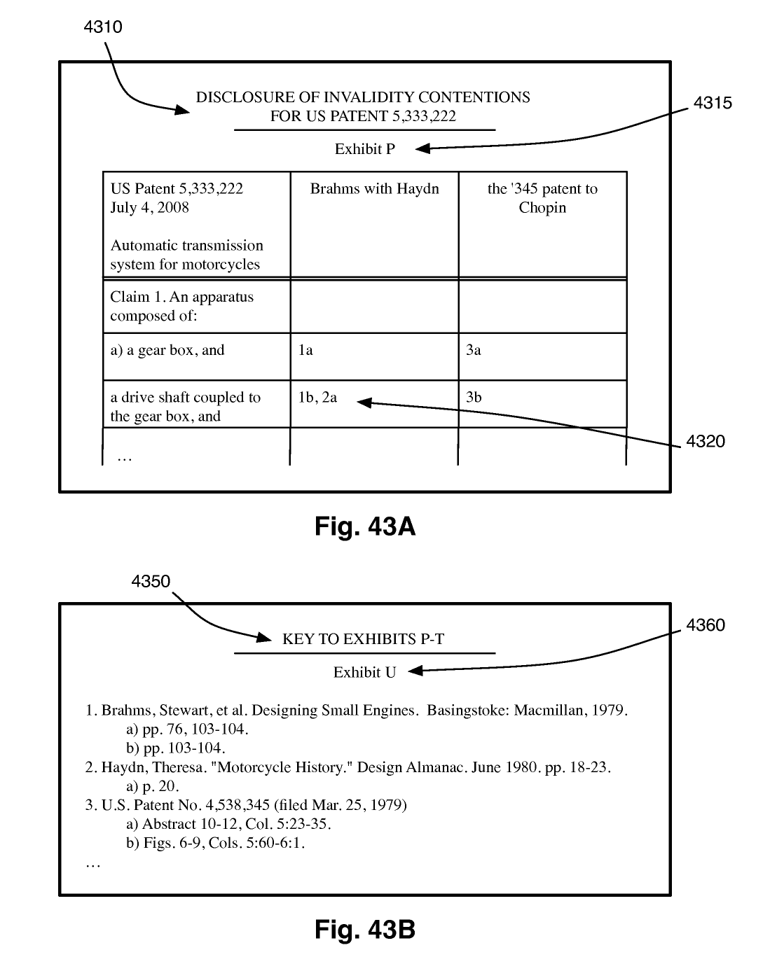

The programmed processor system 4438 uses the ICK report data structure to generate an ICK report file. The structure of the ICK report file is similar to the structure of the ICC report file. The ICK report file differs in two ways from the ICC report file. First, the prior art columns do not contain the citation list for the relevant excerpts. Instead, the columns contain a list of two-part codes 4320. Each code comprises a number and a letter. The number refers to an item in the key for a particular reference. The letter refers to a sub-item of the reference that contains a citation list. FIG. 43a shows the two-part codes in the context of a chart. The second difference between the ICC and ICK report files is that the ICK report file appends a final exhibit containing the key. FIG. 43b shows the key used for mapping the codes to citation lists. The key is a two-level outline. The top level is a numbered list of references. The references are identified by their citation property. The second level is a lettered list of citation lists. These citation lists represent the relevant evidence just as described above for the ICC report.

The programmed processor system 4438 generates the ICK report file using a variation on the method used for the ICC report. When the programmed processor system 4438 generates a citation list, it performs two checks. First, it checks to see if the reference cited by the list is already in the top-level list in the key. If not, the programmed processor system 4438 adds the value of the references citation property to the top-level list. Second, the programmed processor system 4438 checks to see if the citation list already appears in the second-level list under the reference. If not, it adds the citation list to the second-level list. After these checks, the programmed processor system 4438 constructs the two-part code that identifies the location of the reference and citation list in the key and puts the code in the prior art column of the chart where the ICC report would put the entire citation list. If the prior art is a combination, the programmed processor system 4438 uses this method to assemble a list of two-part codes, one for each reference containing excerpts relevant to the element for that row.

The programmed processor system 4438 generates a final exhibit after the charts. This exhibit contains the key for the two-part codes used in the chart. The key has a header. The header begins with the key title 4350, created using the key title template property. The programmed processor system 4438 scans the key title template for occurrences of replacement codes. These codes refer to properties of the report file. For example, the code “% (exhibitRange)s” refers to a text phrase describing the range of exhibits covered by the key. The programmed processor system 4438 replaces each occurrence of a replacement code with the value of the property to which it refers. For example, when generating the key for a report containing exhibits “P” through “T”, it converts the template “Key to % (exhibitRange)s of the disclosure” to “Key to exhibits P-T of the disclosure.” The second part of the header is the exhibit letter 4360 of the key itself. After the header, the programmed processor system 4438 generates the two-level outline described above.

Additional Reports

Although not shown for purposes of clarity, additional reports can be provided. For example, a Reverse Tags report that is similar to the Tags Report can be provided. In a Reverse Tags report, instead of listing each element followed by any tags associated with that element, it lists each tag followed by any elements associated with that tag. The Excerpts By Tag report is similar to the References Report, except instead of listing each excerpt followed by any tags associated with that excerpt, it lists each tag followed by any excerpts associated with that tag. These excerpts can be sorted by their associated rating.

### Operation of the System

In operation, the invention organizes and presents evidence relevant to a set of statements. For example, the statements can be the elements of patent claims, and the evidence can be a set of excerpts from prior art references that the user or other person argues anticipate the claim elements. The method by which the invention operates, in response to user input, is described below with regard to FIG. 46. It should be noted that although the operational blocks shown in FIG. 46 are described below in the order in which they are shown in FIG. 46 for purposes of illustration, the operations described by the blocks can occur in any suitable order with respect to each other. Similarly, the use of the term “step” or term suggesting an order (e.g., “first,” “next,” etc.) in connection with a block or operation is for purposes of illustration and is not intended to imply that steps cannot be performed in another suitable order. Furthermore, in other embodiments of the invention the operations described by one block can overlap or be combined with those described by other blocks.

Block 4610—Identify Statements

As indicated by block 4610, a set of statements is first identified. In the exemplary embodiment, the user identifies a set of claim elements that belong to one or more patents. The user first uses the programmed processor system 4438 to create a new document window 100, as shown in FIG. 1. Next, the user enters information about each patent against which an anticipation case is being built. The user adds a new patent to the document window using the “New Patent” button 500 shown in FIG. 6. Then, the user provides values for each property of the patent using the Patent Editing Pane 600, shown in FIG. 7. The user can set the name property to an abbreviation of the information identifying the patent. The patent number, issue date, and title are taken from the patent itself. The note contains information the user wishes to record about the patent.

The anticipation case against a patent is directed against a set of claims. A claim is text describing the patented invention. This text is customarily broken down into smaller portions describing individual elements, steps, or relationships. These portions are called “claim elements” or just “elements.” A claim preamble is also an element. After adding a patent to the document window, the user adds the elements for each patent. The user adds a new element to a patent using the “Add Element” button 520 shown in FIG. 7. Then, the user provides values for each property of the element using the Element Editing Pane 700, shown in FIG. 8.

The user makes notes in the note fields of patents and elements. These notes record information, advice, and opinions about each item. For example, a note records some detail about an item that the user wishes to communicate to others, such as a patent's place in the patent family tree, or the reason why a claim element was added to the case.

The user evaluates the collection of patents to ensure that all relevant patents, and no others, are present. The user may add or remove patents as they are added to or removed from the case. The user uses the navigation pane 110 to select a patent. The user removes the selected patent using the Delete button 510. The user also evaluates the claim elements to ensure that all relevant claims, and no others, are present. The user also evaluates whether the claims are correctly broken down into elements. The user may add or remove claim elements as claims are added to or removed from the case, or as the breakdown of a claim into elements changes. The user uses the patent content pane 400 to select an element. The user removes the selected element using the Delete button 720.

Block 4620—Tag Statements with Arguments

As indicated by block 4620, the statements are “tagged” by associating each statement with one or more argument tags. In the exemplary embodiment, the user frames the anticipation case by explicitly enumerating the arguments to be proven about each claim element. FIG. 11 shows element 480, “a drive shaft coupled to the gear box.” The user chooses the arguments he wishes to prove. For example, the user might choose to argue that a drive shaft is disclosed by the prior art. The user might further choose to argue that coupling a gear box to a drive shaft is disclosed by the prior art. Anticipation arguments like these are based on concepts derived directly from the claim element, but arguments may also arise from other concerns related to the case. The strategic needs of the user shape the set of arguments in ways not considered by the authors of the patents. For example, the user may argue that a certain person or group understood something at a certain time, that a related idea would have suggested itself, or that a particular product had a feature similar to that claimed.

The user uses a tag to model each argument. The user adds a new tag to the document window using the “New Tag” button 930 shown in FIG. 10. Then, the user provides values for properties of the tag using the Tag Editing Pane 900, shown in FIG. 10. The user enters a description of the argument in the text field 910. This description can be a concise phrase that abbreviates the full argument. For example, the phrase “Box Coupling” abbreviates the argument that coupling a gear box to a drive shaft is disclosed by the prior art. The user enters a note with additional clarifying or otherwise helpful information in the note field 920. This separation between the text of a tag and its note allows the user to present the argument concisely in the programmed processor system 4438, without sacrificing content.

The user associates an element with the applicable tags by creating taggings. The user adds a new tagging to an element using the “Add Tagging” button 730 shown in FIG. 8. Then, the user uses the Tag Selection Window 1100, shown in FIG. 12, to choose the tag to associate with the element. Then, the user annotates the association using the Element Tagging Editing Pane 1200 shown in FIG. 13.

When multiple statements require the same argument, the user applies the argument tag to each statement. For example, a patent may have a number of claims that are similar in scope. These claim elements will share many of the same tags. Likewise, a case may contain several related patents. These patents will also share the same tags. After all of the patents and claim elements have been tagged, the resulting list of tags describes the case arguments as completely as, yet more concisely than, a list of claim elements. By associating the same tag with each applicable element, the user need not take redundant steps to apply the same evidence to every element to which an argument applies.

The user presents the set of tags, along which their association to the claim elements, in a tags report. The user adds a new tags report to the document window using the “New Report” button 2660 shown in FIG. 26. Then, the user chooses the tags report type 2710 using the Report Type Selection Window 2700. Then, the user chooses the report name 2610, the file name prefix 2620, the target folder 2630, and the report format 2640 using the Report Editing Pane 2600 shown in FIG. 26. The user next uses the Tags Report Options Window 2900 to set the chart title template property 2910. The user customizes the default template as needed, using replacement codes such as “% (number)s” to indicate where the patent number should be inserted in the title for each chart.

The user has the option of limiting the report to selected patents of interest by pressing the Patents button 2940. In that case, the user uses the Patent Collection Editing Window 3000 to select the patents to include in the report. This limiting allows the user to reduce the size of the report.

The user generates the tags report using the Generate button 2690, shown in FIG. 26. The programmed processor system 4438 creates a tags report file that may be read on-screen or printed. The user may also distribute the report file to others who are interested in the case. The user updates the data in the document window based on the user's impressions from the report, or based on the impressions of other readers.

In this step, the user evaluates the collection of tags to identify missing arguments that should be added, existing arguments that should be changed, or arguments that should be removed. For example, the user reviews the entire annotated list of tags presented in the tags report, as shown in FIG. 28a.

The user uses the navigation pane 110 and the Tags Collection Content Pane 800, shown in FIG. 9, to select a tag. The user changes the tag text using the Text field 910. The user removes a selected tag using the Delete button 940. The user also evaluates the element taggings to identify missing tags that should be associated with the element, or taggings that should be removed from the element. For example, the user reviews the annotated element taggings presented in the tags report, as shown in FIG. 28b. The user removes an element tagging using the Delete button 1230. The user also re-evaluates the breakdown of claims into claim elements, and the process returns to block 4610 if changes are needed. The user updates the annotations in the note fields as needed. The user iterates this step until each element is tagged with the appropriate arguments.

Block 4630—Identify Evidence

As indicated by block 4630, evidence items that may be relevant to the statements are identified. In the exemplary embodiment, the user relies on prior art references for evidence to prove arguments. The set of tags developed in block 4620 guide the user in identifying those references. References relating to the arguments represented by the set of tags are more likely to provide helpful evidence. The present invention need not otherwise help the user identify prior art references.

After locating the references, the user enters information about each identified reference. The user adds a new reference to the document window using the “New Reference” button 1510 shown in FIG. 15. Then, the user provides values for each property of the reference using the Reference Editing Pane 1600, shown in FIG. 16. The user can set the name property to an abbreviation of the information identifying the reference. The user enters the citation for the reference using a citation style such as the Bluebook. The note contains information the user wishes to record or to communicate to others about the reference.

Block 4640—Tag Evidence with Arguments

As indicated by block 4640, evidence is “tagged” by associating each evidence item with one or more argument tags. In the exemplary embodiment, the user collects useful evidence by identifying passages in a reference that support an argument the user wants to make. The user excerpts the passage and adds the excerpt to the reference using the “Add Excerpt” button 1640 shown in FIG. 16. Then, the user provides values for properties of the excerpt using the Excerpt Editing Pane 1700, shown in FIG. 17. The user can duplicate the passage in the text property. The user enters the sub-cite 1710 that locates the excerpt within the reference. The user also records additional information in the note field.

The user records the arguments supported in an excerpt by explicitly associating each of the argument tags with the excerpt. FIG. 14 shows an exemplary excerpt 1370, “In this chapter, we discuss several methods for connecting the drive shaft to the gear box.” FIG. 14 also shows that the user associated three tags with this excerpt: “Box Coupling” 1390, “Gear Box” 1400, and “Drive Shaft” 1410. The association between an excerpt and a tag is called an “excerpt tagging,” or just a “tagging.” The user adds a new tagging to an excerpt using the “Add Tagging” button 1740 shown in FIG. 17. Then, the user chooses the tag to associate using the Tag Selection Window 1100, shown in FIG. 12. Then, the user edits the association using the Excerpt Tagging Editing Pane 1800 shown in FIG. 18. The user can also use the rating field 1840 to indicate how strongly the excerpt supports the argument tag. A higher rating indicates stronger support. The user can also note the reasons for the particular rating in the note field 1850.

The user presents the excerpts, along which their association to the argument tags, in a references report. The user adds a new references report to the document window using the “New Report” button 2660 shown in FIG. 26. Then, the user chooses the references report type 2720 using the Report Type Selection Window 2700. Then, the user sets report properties using the Report Editing Pane 2600 shown in FIG. 26 as described above for the tags report. The user next uses the References Report Options Window 3100 to set the chart title template property 3110. The user customizes the default template as needed, using replacement codes such as “% (name)s” to indicate where the reference name should be inserted in the title for each chart.

The user has the option of limiting the report to selected references of interest by pressing the References button 3140. In that case, the user uses the Reference Collection Editing Window 3200 to select the references to include in the report. This limiting allows the user to reduce the size of the report.

The user generates the references report using the Generate button 2690, shown in FIG. 26. The programmed processor system 4438 creates a report file that may be read on-screen or printed. The user may also distribute the report file to others who are interested in the case.

After reading the references, the user (or another reader) evaluates whether or not the arguments are formulated correctly. The user may discover, for example, that a reference illuminates a new argument, or a refinement of an existing argument. In this case, the process can return to block 4620, with the user reformulating the tags. The user, or another reader, also evaluates if the right passages have been excerpted. The user can add, edit or delete excerpts as needed. The user uses the reference content pane 1300 to select an excerpt. The user removes the selected excerpt using the Delete button 1630.

The user also evaluates if the argument tags have been associated correctly with the excerpts. For example, the user reviews excerpt taggings in the references report, as shown in FIG. 33a, as well as the list of unused tags 3350, as shown in FIG. 33b. The user uses the Reference Content Pane 1300, shown in FIG. 14, to select an excerpt tag. The user updates the data in the document window based on the user's impressions from the report, or based on the impressions of other readers. The user deletes an excerpt tagging using the Delete button 1810. The user changes the rating of an excerpt tagging using the Rating slider 1840. Depending on the impressions from the references report, the user repeats this step or returns to a previous step. The user updates the annotations in the note fields as needed. The user iterates this step until each reference is properly excerpted and tagged with the appropriate arguments.

Block 4650—Collect Relevant Evidence

As indicated by block 4650, the fifth step is collecting the relevant evidence for each statement, where relevance is indicated between an evidence item and a statement by at least one argument tag shared between the evidence tags and the statement tags. In the exemplary embodiment, the user evaluates the strength of the anticipation case against each claim for each reference. The user presents the detailed anticipation case in an anticipation report. The user adds a new anticipation report to the document window using the “New Report” button 2660 shown in FIG. 26. Then, the user chooses the anticipation report type 2730 using the Report Type Selection Window 2700. Then, the user sets report properties using the Report Editing Pane 2600 shown in FIG. 26 as described above for the tags report.

The user next uses the Anticipation Report Options Window 3700 to set additional properties. The user edits the Chart Title Template field 3710. The user customizes the default template as needed, using replacement codes such as “% (patent-name)s” and “% (prior-art-name)s” to indicate where the patent or reference name should be inserted in the title for each chart. The user uses the slider 3715 to set the minimum rating an excerpt tagging may have in order to be included in the report. This minimum rating allows the user to restrict the report to evidence giving stronger support for an argument. The user also has the option of reducing the size of the report by limiting the patents and prior art that is included. The user can limit the report to selected patents of interest by pressing the Patents button 3740. In that case, the user uses the Patent Collection Editing Window 3000 to select the patents to include in the report. The user can limit the report to selected prior art of interest by pressing the Prior Art button 3750. In that case, the user uses the Prior Art Collection Editing Window 3400 to select the prior art to include in the report.

The user generates the anticipation report using the Generate button 2690, shown in FIG. 26. The programmed processor system 4438 creates a report file that may be read on-screen or printed. The user may also distribute the report file to others who are interested in the case.

In this step, the user evaluates the anticipation case. The user (or another reader) reviews the anticipation report shown in FIG. 38. For each element, the user examines each excerpt. The user evaluates whether the excerpt supports the correct arguments in light of the specific claim. The user also evaluates whether the strength of the excerpt's support for an argument matches its rating. For example, the user reviews the list of relevant excerpt taggings 3850. The user also evaluates the volume of evidence cited against a claim element. The user controls the volume of cited evidence by adjusting the minimum rating threshold, adjusting the rating of the excerpt taggings, or by removing excerpt taggings. The user also evaluates the tags that are not supported by the cited evidence. For example, the user reviews the list of missing tags 3860 in the chart row. This list shows where the currently cited evidence is deficient. If needed, the process returns to block 4640, with the user adjusting the excerpt taggings, or returns to block 4620, with the user adjusting the element taggings.

For each section in the anticipation report, the user examines the strength of the prior art against the patents. If the user identifies arguments that the prior art does not sufficiently support, the user has the option of combining that prior art with another reference. In that case, the user creates a combination using the “New Combination” button 2010 shown in FIG. 20. Then, the user provides values for each property of the combination using the Combination Editing Pane 2100, shown in FIG. 21. The user combines the original reference with a new reference (or references) that addresses the arguments on which the original is weaker. The user adds each reference to the combination using the “Add Reference” button 2130 and the Reference Selection Window 2300. The user next evaluates whether a reference should be cited for all tags, or just for those tags which the other references in the combination do not strongly support. The user restricts the tags for which a reference should be cited using the “Restrictions” button 2240 shown in FIG. 22, as well as the Tag Restrictions Window 2400 shown in FIG. 24. The user generates an anticipation chart for the new combination and repeats this step to evaluate the result. The user iterates this step until the anticipation case is ready for presentation.

Block 4660—Present Relevant Evidence for Each Statement

As indicated by block 4660, the sixth step is presenting the relevant evidence for each statement. In the exemplary embodiment, the user presents the anticipation case as a series of invalidity charts. These charts are usually formatted for filing with a court. The user has the option of generating these charts as an Invalidity Chart with Citations (ICC) Report or as an Invalidity Chart with Key (ICK) Report. The user adds a new ICC report to the document window using the “New Report” button 2660 shown in FIG. 26. Then, the user chooses the ICC report type 2740 using the Report Type Selection Window 2700. Then, the user sets report properties using the Report Editing Pane 2600 shown in FIG. 26 as described above for the tags report.

The user next uses the ICC Report Options Window 3900 to set additional properties. The user edits the Chart Title Template field 3910. The user customizes the default template as needed, using replacement codes such as “% (patent-number)s” to indicate where the patent number should be inserted in the title for each chart. The user uses the text field 3920 to set the starting exhibit letter to the next letter in the user's exhibit sequence. The user uses the slider 3715 to set the minimum rating an excerpt tagging may have to be included in the report. This minimum rating allows the user to restrict the report to evidence giving stronger support for an argument. The user also has the option of reducing the size of the report by limiting the patents and prior art that is included. The user can limit the report to selected patents of interest by pressing the Patents button 3950. In that case, the user uses the Patent Collection Editing Window 3000 to select the patents to include in the report. The user can limit the report to the prior art that best supports the case by pressing the Prior Art button 3960. In that case, the user uses the Prior Art Collection Editing Window 3400 to select the prior art to include in the report.

The user generates the ICC report using the Generate button 2690, shown in FIG. 26. The programmed processor system 4438 creates a report file that may be read on-screen or printed. The user may also distribute the report file to others who are interested in the case.

The user adds a new ICK report to the document window using the “New Report” button 2660 shown in FIG. 26. The user follows the same steps to configure and use the ICK report as those followed for the ICC report. For the ICK report, the user also sets the key title template 4220.

While one or more exemplary embodiments of the invention have been described, it will be apparent to those of ordinary skill in the art that still other embodiments are possible that are within the scope of this invention. Accordingly, the invention is not to be restricted except in light of the following claims.

What is claimed is:

1. A computer program product, comprising a computer readable medium having computer readable program code stored thereon in computer-executable format, said computer readable program code, when executed by a computer, causing the computer to effect a method comprising:
accepting as input a set of statements, a set of argument tags associated with each statement, a set of evidence items, and a set of argument tags associated with each evidence item;
collecting, for each statement, the group containing any evidence item that is relevant to the statement, where relevance is indicated by at least one argument tag shared between the argument tags associated with the statement and the argument tags associated with the evidence item; and
presenting the set of statements and, for each statement, the evidence items relevant to the statement.

2. The computer program product of claim 1, wherein the method effected by the computer further includes presenting, for each evidence item relevant to a statement, the argument tags shared between the argument tags associated with the statement and the argument tags associated with the evidence item.

3. The computer program product of claim 1, wherein the method effected by the computer further includes:
accepting as input an annotation for an item, where an item is one of a statement, an argument tag, an evidence item, and an association of an argument tag with a statement or evidence item; and
presenting the annotation along with the item.

4. The computer program product of claim 1, wherein:
the set of evidence items comprises excerpts from one or more references, each reference having a citation, and each excerpt having a sub-citation within a reference; and
the method effected by the computer further includes presenting the citation and sub-citation of the evidence items presented.

5. The computer program product of claim 4, wherein the method effected by the computer further includes combining the sub-citations of the evidence items relevant to a statement into a more concise representation for presentation.

6. The computer program product of claim 4, wherein the set of statements comprises elements of one or more claims of one or more patents.

7. The computer program product of claim 6, wherein the argument tags associated with each element represent anticipation arguments.

8. The computer program product of claim 6, wherein the argument tags associated with each element represent enablement arguments.

9. The computer program product of claim 6, wherein the argument tags associated with each element represent infringement arguments.

10. The computer program product of claim 1, wherein the method effected by the computer further includes:
accepting as input a threshold rating and a rating for each association of an argument tag with an evidence item; and
excluding from the set of argument tags associated with each evidence item all argument tags rated below the threshold rating.

11. A computing system, comprising:
a user interface comprising a screen display and one or more input devices; and
a processor system comprising one or more processors and associated memory, the processor system programmed or configured to include:
accepting logic for accepting as input via the user interface a set of statements, a set of argument tags associated with each statement, a set of evidence items, and a set of argument tags associated with each evidence item;
collecting logic for collecting, for each statement, the group containing any evidence item that is relevant to the statement, where relevance is indicated by at least one argument tag shared between the argument tags associated with the statement and the argument tags associated with the evidence item; and
presenting logic for presenting via the user interface the set of statements and, for each statement, the evidence items relevant to the statement.

12. The computing system of claim 11, wherein the processor system is further programmed or configured to present, for each evidence item relevant to a statement, the argument tags shared between the argument tags associated with the statement and the argument tags associated with the evidence item.

13. The computing system of claim 11, wherein the processor system is further programmed or configured to accept as input an annotation for any item, where an item is one of a statement, an argument tag, an evidence item, and an association of an argument tag with a statement or evidence item, and to present the annotation along with the item.

14. The computing system of claim 11, wherein:
the set of evidence items comprises excerpts from one or more references, each reference having a citation, and each excerpt having a sub-citation within a reference; and
the processor system is further programmed or configured to present the citation and sub-citation of the evidence items presented.

15. The computing system of claim 14, wherein the processor system is further programmed or configured to combine the sub-citations of the evidence items relevant to a statement into a more concise representation before they are presented.

16. The computing system of claim 14, wherein the set of statements comprises elements of one or more claims of one or more patents.

17. The computing system of claim 16, wherein the argument tags associated with each element represent anticipation arguments.

18. The computing system of claim 16, wherein the argument tags associated with each element represent enablement arguments.

19. The computing system of claim 16, wherein the argument tags associated with each element represent infringement arguments.

20. The computing system of claim 11, wherein the processor system is further programmed or configured to:
accept as input a threshold rating and a rating for each association of an argument tag with an evidence item; and
exclude from the set of argument tags associated with each evidence item all argument tags rated below the threshold rating.

21. A method effected by a computing system having a user interface and a programmed processor system, the method comprising:
the computing system accepting as input via the user interface a set of statements, a set of argument tags associated with each statement, a set of evidence items, and a set of argument tags associated with each evidence item;
the computing system collecting, for each statement, the group containing any evidence item that is relevant to the statement, where relevance is indicated by at least one argument tag shared between the argument tags associated with the statement and the argument tags associated with the evidence item; and
the computing system presenting via the user interface the set of statements and, for each statement, the evidence items relevant to the statement.

22. The method of claim 21, wherein the method further includes the computing system presenting, for each evidence item relevant to a statement, the argument tags shared between the argument tags associated with the statement and the argument tags associated with the evidence item.

23. The method of claim 21, wherein the method further includes:
the computing system accepting as input an annotation for any item, where an item is one of a statement, an argument tag, an evidence item, and an association of an argument tag with a statement or evidence item; and
the computing system presenting via the user interface the annotation along with the item.

24. The method of claim 21, wherein:
the set of evidence items comprises excerpts from one or more references, each reference having a citation, and each excerpt having a sub-citation within a reference; and
wherein the method further includes the computing system presenting the citation and sub-citation of the evidence items presented.

25. The method of claim 24, wherein the method further includes the computing system combining the sub-citations of the evidence items relevant to a statement into a more concise representation for presentation.

26. The method of claim 24, wherein the set of statements comprises elements of one or more claims of one or more patents.

27. The method of claim 26, wherein the argument tags associated with each element represent anticipation arguments.

28. The method of claim 26, wherein the argument tags associated with each element represent enablement arguments.

29. The method of claim 26, wherein the argument tags associated with each element represent infringement arguments.

30. The method of claim 21, wherein the method further includes the computing system accepting as input a threshold rating and a rating for each association of an argument tag with an evidence item; and then excluding from the set of argument tags associated with each evidence item all argument tags rated below the threshold rating.
